(19) United States
(12) Patent Application Publication
(10) Pub. No.: US 2007/0291355 A1
(43) Pub. Date: Dec. 20, 2007

(54) Image display apparatus, head-mounted display, and optical axis adjustment method

(75) Inventor: Yasushi Tanijiri, Osakasayama-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/811,635

(22) Filed: Jun. 11, 2007

(30) Foreign Application Priority Data
Jun. 14, 2006 (JP) 2006-164690

(51) Int. Cl. G02B 27/22

(52) U.S. Cl. 359/467

(57) ABSTRACT

At least one of right and left image display apparatuses is provided with an optical axis adjustment mechanism. The optical axis adjustment mechanism changes relative positional relationship between an image displayed on a display device and an ocular optical system in a direction intersecting an optical axis to thereby adjust an angle formed by a pair of right and left optical axes. In this condition, a light source is so arranged as to be substantially conjugate with an optical pupil. The optical axis adjustment mechanism changes the positional relationship described above without changing a position of the optical pupil relative to the ocular optical system. This permits, even when the apparatus is originally designed such that light intensity is high at a designed optical pupil position, achieving the light intensity at this optical pupil position even after optical axis adjustment. Moreover, since the position of the optical pupil relative to the ocular optical system is not changed through the optical axis adjustment, image light can be guided to the optical pupil by utilizing a portion of the ocular optically system designed so as to suppress occurrence of aberration.

This application is based on Japanese Patent Application No. 2006-164690 filed on Jun. 14, 2006, the contents of which are hereby incorporated by reference.

### BACKGROUND OF THE INVENTION

1. Field of the Invention

The present invention relates to an image display apparatus which provides to an observer an image displayed on a display device as a virtual image, a head-mounted display (hereinafter also referred to as HMD) provided with this image display apparatus, and an optical axis adjustment method.

2. Description of Related Arts

Conventionally, an HMD has been proposed which permits an observer to observe images displayed on a pair of right and left display devices with his or her both eyes. When the observer is fitted with such a binocular HMD, he or she observes the right and left displayed images as one image by superimposing them on each other. In this condition, if respective positions of optical axes of right and left optical systems shift whereby an angle formed by the pair of right and left optical axes deviates from a criterion, the observer has difficulty in observing the displayed images by superimposing them on each other.

Thus, for example, an apparatus disclosed in patent document 1 is capable of adjusting an optical axis in at least one of right and left optical systems in a direction vertical to a direction in which the both eyes are arranged (horizontal direction). Here, FIG. 31 is an explanatory diagram schematically showing general structure of one of the right and left optical systems in the apparatus disclosed in patent document 1. As shown in FIG. 31, a light source 101 and a liquid crystal panel 102 can be integrally moved in a vertical direction to thereby adjust the optical axis in the vertical direction. In FIG. 31, solid lines indicate positions of the light source 101 and the liquid crystal panel 102 and an optical path before the movement, and broken lines indicate positions of the light source 101 and the liquid crystal panel 102 and an optical path after the movement.

For example, an apparatus disclosed in patent document 2 has an adjustment mechanism provided at a bridge portion of an HMD, that is, a portion coupling together ocular windows arranged in front of the both eyes. The adjustment mechanism adjusts an interval between the ocular windows in accordance with the convergence of the observer. The positional relationship between right and left optical axes can be adjusted by this adjustment mechanism, but the detailed configuration of the adjustment mechanism is not clarified.

Patent documents 1 and 2 described above are as follows.

[Patent Document 1] JP-A-H8-240785

[Patent Document 2] JP-A-2000-19450

Patent document 1 specifies no positional relationship between the light source 101 and an optical pupil E in the apparatus. Therefore, moving the light source 101 and the liquid crystal panel 102 relative to the lens 103 shifts the position of the optical pupil E relative to the lens 103 in the apparatus, as shown in FIG. 31. Thus, the luminance of an observed image may deteriorate, or the quality of the observed image may degrade due to occurrence of great aberration.

Specifically, for example, when the light source 101 is formed of a point light source, or when a diffuser plate is arranged on the optical path, considering a radiation characteristic of the light source 101 and a diffusion characteristic of the diffuser plate, the apparatus is typically designed such that the light intensity is high at the position of the optical pupil E before optical axis adjustment. Therefore, as in FIG. 31, the shift of the position of the optical pupil E relative to the lens 103 due to the optical axis adjustment locates the optical pupil E at position where the intensity of reaching light is lower than that at the position of the optical pupil E before the optical axis adjustment. As a result, an image observed at the position of the optical pupil E after the optical axis adjustment is dark.

Moreover, the shift of the position of the optical pupil E relative to the lens 103 results in use of a portion remotely separated from a portion of the lens 103 designed so as to suppress occurrence of aberration (to transmit light), thus causing great aberration. Therefore, at the position of the optical pupil E after the optical axis adjustment, the quality of an observed image degrades.

### SUMMARY OF THE INVENTION

The present invention has been made to solve the problem described above, and it is an object of the invention to provide an image display apparatus capable of avoiding luminance deterioration and image quality degradation of an observed image caused by optical axis adjustment, a head-mounted display including this image display apparatus, and an optical axis adjustment method.

In order to solve the problem described above, an image display apparatus according to one aspect of the invention includes: a pair of right and left light sources, a pair of right and left display devices which modulate light from the respective light sources to display images, a pair of right and left observation optical systems which guide light of the images displayed on the respective display devices to a pair of right and left optical pupils, respectively, and an optical axis adjustment mechanism which, for at least one of right and left, changes relative positional relationship between the image displayed on the display device and the observation optical system in a direction intersecting an optical axis to thereby adjust an angle formed by a pair of right and left optical axes. On each of the right and left, the light source is so arranged as to be substantially conjugate with the optical pupil. The optical axis adjustment mechanism changes the positional relationship without changing a position of the optical pupil relative to the observation optical system.

An optical axis adjustment method according to another aspect of the invention includes the step of adjusting an angle formed by a pair of right and left optical axes in an image display apparatus having light sources, display devices, and observation optical systems all in pairs each on right and left and having, on each of the right and the left, the light source and the optical pupil so arranged as to be substantially conjugate with each other. In the step, for at least one of the right and the left, without changing a position of the optical pupil relative to the observation optical system, relative positional relationship between an image displayed on the display device and the observation optical system is changed in a direction intersecting the optical axis to thereby adjust the angle formed by the pair of right and left optical axes.

With the configuration described above, on each of the right and the left, the light emitted from the light source is modulated by the display device and then guided as an image light to the optical pupil via the observation optical system. Consequently, the observer can locate his or her right and left eyes respectively at positions of the right and left optical pupils to thereby observe the displayed images with the respective eyes.

Here, the optical axis adjustment mechanism, for at least one of the right and the left, changes the relative positional relationship between the image displayed on the display device and the observation optical system in the direction intersecting the optical axis to thereby adjust the angle formed by the pair of right and left optical axes to thereby perform optical axis adjustment. The change of the positional relationship described above may be achieved by adjusting a position of the display device in the direction intersecting the optical axis, or may be achieved by changing a display position of the image displayed on the display device without adjusting the position of the display device.

In this condition, on each of the right and the left, the light source is so arranged as to be substantially conjugate with the optical pupil, so that the optical axis adjustment mechanism can change the positional relationship described above to thereby perform optical axis adjustment without changing the position of the optical pupil relative to the observation optical system. Performing such optical axis adjustment by the optical axis adjustment mechanism permits, even when, for example, the apparatus is originally designed such that light intensity is high at a designed optical pupil position, achieving the light intensity at this optical pupil position even after the optical axis adjustment. Therefore, luminance deterioration of an observed image at the optical pupil position caused by the optical axis adjustment can be avoided.

The optical axis adjustment mechanism performs the optical axis adjustment without changing the position of the optical pupil relative to the observation optical system, thus permitting the image light from the display device to be guided to the optical pupil by using, for example, a portion of the observation optical system designed so as to suppress occurrence of aberration (without using a portion distant from the aforementioned portion as much as possible). This permits suppressing occurrence of aberration attributable to the optical axis adjustment, thus avoiding image quality degradation of an observed image caused by the occurrence of aberration.

The head-mounted display of the invention includes the image display apparatus of the present invention and support member adapted to support the image display apparatus in front of eyes of the observer. With this configuration, in which the image display apparatus is supported by the support member, the observer can observe images provided from the image display apparatus in a handsfree manner.

### BRIEF DESCRIPTION OF THE DRAWINGS

The objects described above and other objects of the invention will be more clarified by referring to description of the preferred embodiments below and also to the accompanying drawings showing the following.

FIG. 1 is an explanatory diagram showing expanded optical paths of light exiting from the centers of display regions of display devices in right-eye and left-eye image display apparatuses, respectively, according to one embodiment of the invention;

FIG. 2 is an explanatory diagram showing expanded optical paths of light emitted from light sources of the respective image display apparatuses;

FIG. 3 is an explanatory diagram showing expanded optical paths of light exiting from the centers of display regions of display devices in another configuration example of the respective image display apparatuses;

FIG. 4 is an explanatory diagram showing expanded optical paths of light emitted from light sources of the respective image display apparatuses with the configuration described above;

FIG. 5 is an explanatory diagram showing expanded optical paths of light exiting from the centers of display regions of display devices in still another configuration example of the respective image display apparatuses;

FIG. 6 is an explanatory diagram showing expanded optical paths of light exiting from light sources of the respective image display apparatuses with the configuration described above;

FIG. 7 is an explanatory diagram showing expanded optical paths of light exiting from the centers of display regions of display devices in still another configuration example of the respective image display apparatuses;

FIG. 8 is an explanatory diagram showing expanded optical paths of light emitted from light sources of the respective image display apparatuses with the configuration described above;

FIG. 9 is a sectional view showing general configuration of an image display apparatus and one configuration example of an optical axis adjustment mechanism according to another embodiment of the invention;

FIG. 10 is an explanatory diagram showing an optical path optically expanded in one direction in the image display apparatus;

FIG. 11 is a graph showing a radiation characteristic of an LED used as the light source of the image display apparatus;

FIG. 12 is a graph showing a diffusion characteristic of a one direction diffuser plate of the image display apparatus;

FIG. 13 is an explanatory diagram showing light intensity distribution of a given wavelength at optical pupil positions before optical axis adjustment;

FIG. 14 is a sectional view as viewed along an optical axis showing another configuration example of the optical axis adjustment mechanism;

FIG. 15 is a sectional view as viewed along an optical axis showing still another configuration example of the optical axis adjustment mechanism;

FIG. 16 is a sectional view showing general configuration of an optical system used for fabricating a hologram optical element of the image display apparatus;

FIG. 17 is an explanatory diagram showing spectral intensity distribution of the light source;

FIG. 18 is an explanatory diagram showing dependency of diffraction efficiency on wavelengths in the hologram optical element;

FIG. 19 is an explanatory diagram showing color reproduction regions of a virtual image expressed by using XY chromaticity coordinates in an XYZ color coordinate system;

FIG. 20 is an explanatory diagram showing relationship between positions on the optical pupil and main diffracted wavelengths;

FIG. 21 is an explanatory diagram showing expanded optical paths of light exiting from the centers of display regions of display devices in another configuration example of the respective image display apparatuses;

FIG. 22 is an explanatory diagram showing expanded optical paths of light emitted from light sources of the respective image display apparatuses with the configuration described above;

FIG. 23 is an explanatory diagram showing an optical path optically expanded in one direction in image display apparatuses according to still another embodiment of the invention;

FIG. 24 is a plan view of the light source of the image display apparatus as viewed form a display device side;

FIG. 25 is an explanatory diagram showing relationship between positions in an X direction on the optical pupil and light intensities;

FIG. 26 shows another configuration example of the light source, with a plan view of this light source as viewed from the display device side;

FIG. 27 is a sectional view showing general configuration of an image display apparatus according to still another embodiment of the invention;

FIG. 28 is a sectional view showing general configuration of an optical system used for fabricating a hologram optical element of the image display apparatus;

FIG. 29 is a sectional view showing general configuration of an image display apparatus according to still another embodiment of the invention;

FIG. 30A is a plan view showing general configuration of an HMD according to still another embodiment of the invention;

FIG. 30B is a side view of the HMD;

FIG. 30C is an elevation view of the HMD; and

FIG. 31 is an explanatory diagram showing general configuration of one of right and left optical systems in a conventional image display apparatus.

### DETAILED DESCRIPTION OF THE PREFERRED EMBODIMENTS

### First Embodiment

One embodiment of the present invention will be described below, with reference to the accompanying drawings. First, the present embodiment will be described, mainly focusing on principles of optical axis adjustment achieved by an image display apparatus of the invention.

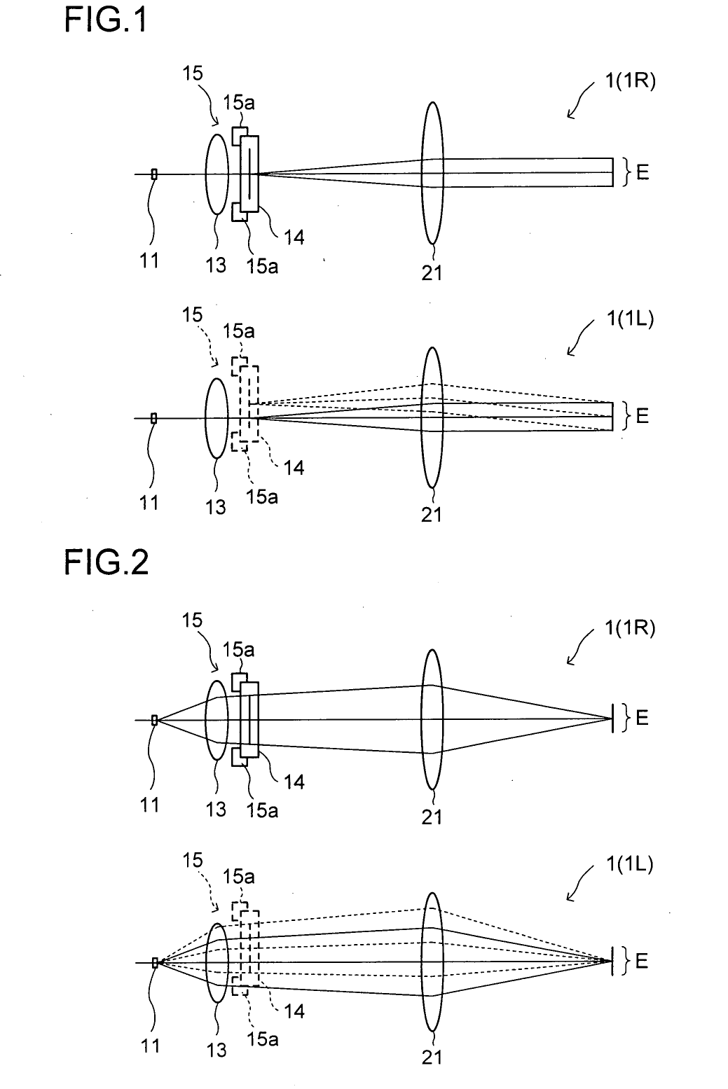

FIG. 1 is an explanatory diagram showing expanded optical paths of light exiting from the centers of display regions of display devices 14 in a right-eye image display apparatus 1R and a left-eye image display apparatus 1L of the present embodiment. FIG. 2 is an explanatory diagram showing expanded optical paths of light emitted from light sources 11 of the respective image display apparatuses 1R and 1L.

The image display apparatus 1 of the present embodiment is composed of the image display apparatuses 1R and 1L which guide light of displayed images respectively to the right and left eyes of an observer. Each of the image display apparatuses 1R and 1L has: the light source 11, a condensing lens 13, the display device 14, an optical axis adjustment mechanism 15, and an ocular optical system 21. That is, the image display apparatuses 1 have the light sources 11, the condensing lenses 13, the display devices 14, the optical axis adjustment mechanisms 15, and the ocular optical systems 21 in pairs each on the right and left.

The light source 11 is formed of LEDs which emit, for example, light of of R (red), G (green), and B (blue) wavelengths, respectively. The condensing lens 13 is an illumination optical system which condenses light from the light source 11 and then guides the light to the display device 14. The display device 14 is a light modulation device which modulates light from the light source 11 to display an image, and is formed of, for example, a transmissive liquid crystal display device.

The optical axis adjustment mechanism 15 is optical axis adjustment means adapted to change relative positional relationship between an image displayed on the display device 14 and the ocular optical system 21 to thereby adjust an angle formed by a pair of right and left optical axes. Hereinafter, the adjustment of the angle formed by the pair of right and left optical axes is called optical axis adjustment. The optical axis here indicates an axis optically linking together the center of a display region of the display device 14 and a principal point of the ocular optical system 21. In the present embodiment, the optical axis adjustment mechanism 15 adjusts a position of the display device 14 relative to the ocular optical system 21 in a direction intersecting the optical axis (including the direction vertical to the optical axis, the direction substantially vertical thereto, the direction diagonal thereto) to change the positional relationship described above, thereby achieving the optical axis adjustment.

More in detail, the optical axis adjustment mechanism 15 has a holding part 15a which holds the display device 14. This holding part 15a is capable of sliding in the direction intersecting the optical axis (here, direction substantially parallel to a display plane of the display device 14), and is finally fixed to a case which stores the display device 14 and the like. Adjusting the position of the display device 14 by sliding the holding part 15a in this manner permits changing in the direction intersecting the optical axis the relative positional relationship between the image displayed on the display device 14 and the ocular optical system 21.

The ocular optical system 21 is an observation optical system which guides light of image displayed on the display device 14 to an optical pupil E, and has an optically positive power. Note that the ocular optical system 21 may have, instead of a lens, any of a hologram optical element, a half mirror, and a free-curved surface prism..

The light source 11 and the optical pupil E are so arranged as to be substantially conjugated with each other by the condensing lens 13 and the ocular optical system 21. Therefore, if a member, such as a diffuser plate or the like, which changes the optical path is not provided on the optical path, an image of the light source 11 is focused on the optical pupil E.

In each of the image display apparatuses 1R and 1L with the configuration described above, light emitted from the light source 11 is condensed by the condensing lens 13 and then guided to the display device 14. The light entering the display device 14, upon being transmitted through pixels of the display device 14, is slightly diffused by the pixels and exits as image light. The image light from the display device 14 is guided to the optical pupil E via the ocular optical system 21. The optical pupil E is moderately sized since the size of the light source 11 is enlarged by image magnification of the optical system and further is slightly increased by the diffusion by the display device 14 described above.

Positional relationship between the light source 11 and the optical pupil E is such that they are substantially conjugate with each other. However, the larger the degree of diffusion, at the pixels, of light transmitted through the display device 14 is, the more difficult it is for the light source 11 and the optical pupil E to be conjugate with each other, so that an image of the light source 11 is not focused clearly on the optical pupil E. On the other hand, the smaller the diffusion described above is, the closer the both approach conjugation, so that intensity distribution of the light emitted from the light source 11 is saved.

In a case of the positional relationship such that the light source 11 and the optical pupil E is substantially conjugate with each other, the position of the display device 14 can be adjusted by the optical axis adjustment mechanism 15 in the direction intersecting the optical axis to change the relative positional relationship between the image displayed on the display device 14 and the ocular optical system 21 to thereby achieve optical axis adjustment without changing a position of the optical pupil E relative to the ocular optical system 21. FIGS. 1 and 2 show, for example, the optical path (indicated by solid lines) before the position of the display device 14 of the image display apparatus 1L is shifted in the direction intersecting the optical axis and the optical path (indicated by broken lines) after this position is shifted. These figures prove that the position of the optical pupil E relative to the ocular optical system 21 does not change before and after the shift of the position of the display device 14.

As described above, the optical axis adjustment can be performed by the optical axis adjustment mechanism 15 without changing the position of the optical pupil E relative to the ocular optical system 21. Therefore, even when the apparatus is originally designed such that light intensity is high at an initially designed optical pupil E position, the light intensity at this optical pupil E can be achieved even after the optical axis adjustment. Therefore, luminance deterioration of an image observed at the position of the optical pupil E caused by the optical axis adjustment can be avoided.

Performing the optical axis adjustment without changing the position of the optical pupil E relative to the ocular optical system 21 permits image light from the display device 14 to be guided to the optical pupil E without utilizing a portion distant from a portion of the ocular optical system 21 designed so as to suppress occurrence of aberration. That is, image light passing through an optical path where optical aberration in the ocular optical system 21 is favorable can be guided to the optical pupil E.

FIGS. 1 and 2 each illustrate that the position where the image light from the display device 14 enters the ocular optical system 21 and the position where this light exits from the ocular optical system 21 greatly differ before and after the optical axis adjustment. However, this illustration is provided in order to clearly describe the principles of the invention in which the optical axis adjustment is performed by movement of the display device 14 without changing the position of the optical pupil E relative to the ocular optical system 21. Thus, change in the both positions as a result of the movement of the display device 14 before and after the optical axis adjustment can be considered to be very small.

As described above, the image light from the display device 14 can be guided to the optical pupil E by utilizing the portion of the ocular optical system 21 designed so as to suppress occurrence of aberration. Therefore, the occurrence of aberration attributable to the optical axis adjustment can be suppressed, thus avoiding image quality degradation of an observed image caused by the occurrence of aberration.

Moreover, the light from the light source 11 is condensed by the condensing lens 13 and then guided to the display device 14. This therefore permits improving the light use efficiency, thus providing an image which is bright to an observer. In addition, the arrangement of the condensing lens 13 permits shortening a distance between the light source 11 and the display device 14, thus achieving a compact, light-weight apparatus.

In FIGS. 1 and 2, the optical axis adjustment mechanisms 15 are provided in pairs on the right and left, but may be provided on at least one of the right and left.

In the present embodiment, the optical axis adjustment is performed by adjusting the position of the display device 14. Alternatively, this may be performed by changing a display position of an image to be displayed on the display device 14 within a display plane. In this case, if the display device 14 has a wider image display region than the image displayed before the optical axis adjustment, the entire image that should be displayed can be displayed even after the optical axis adjustment (after the movement of the display position).

The above description refers to an example where the light source 11 is arranged such that light emitted from the light source 11 (light emitted from one point of the LED) turns into divergent light upon passage through the display device 14. Alternatively, the light source 11 may be arranged such that this light turns into convergent light upon the passage through the display device 14.

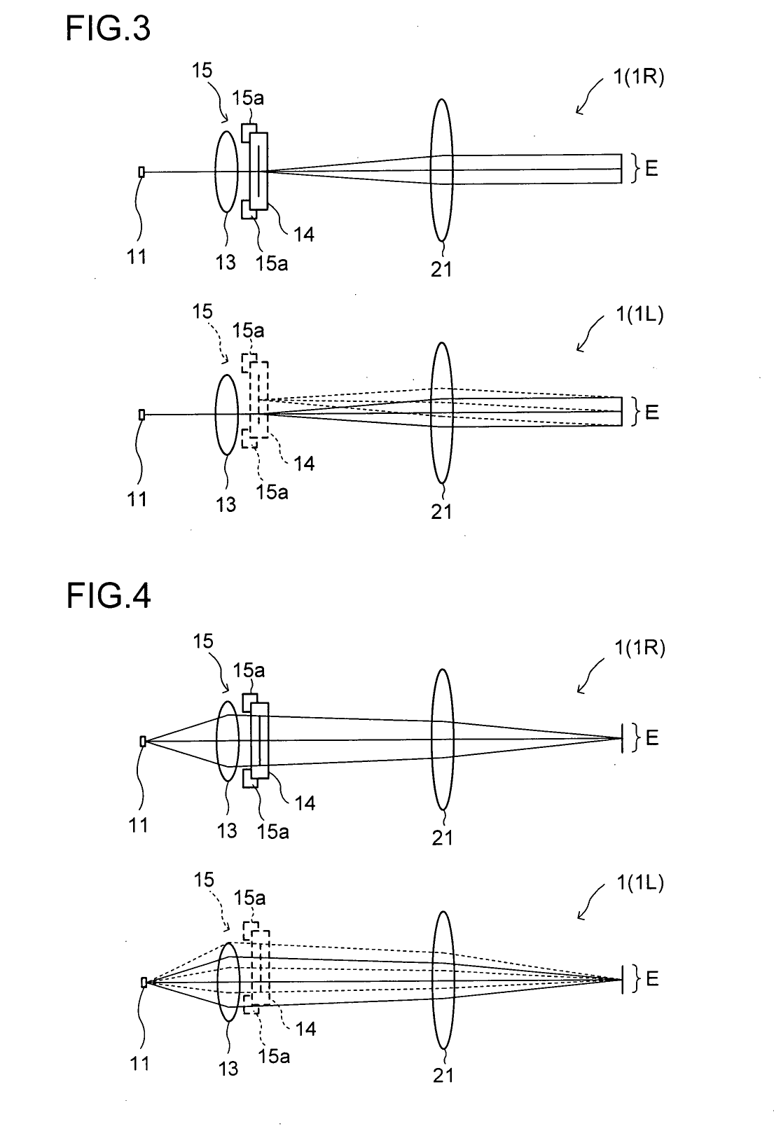

FIG. 3 is an explanatory diagram showing expanded optical paths of light exiting from the centers of the display regions of the display devices 14 in the image display apparatuses 1R and 1L in each of which a distance between the light source 11 and a principal point of the condensing lens 13 is larger than that in FIG. 1. FIG. 4 is an explanatory diagram showing expanded optical paths of light exiting from the light sources 11 of the image display apparatuses 1R and 1L with the configuration of FIG. 3. In these figures, solid lines indicate an optical path before optical axis adjustment, and broken lines indicate an optical path after the optical axis adjustment.

With this configuration, the light source 11 is arranged at a position more distant from the focal position of the condensing lens 13. Even in this case, the optical axis adjustment can be performed by the optical axis adjustment mechanism 15 without changing the position of the optical pupil E relative to the ocular optical system 21. Therefore, as is the case with the configuration of FIGS. 1 and 2, image luminance deterioration and image quality degradation caused by the optical axis adjustment can be avoided.

The image light from the display device 14 may be convergent light by providing the same distance between the light source 11 and the principal point of the condensing lens 13 as those distances in FIG. 1 and FIG. 2 and using the condensing lens 13 having a strong power.

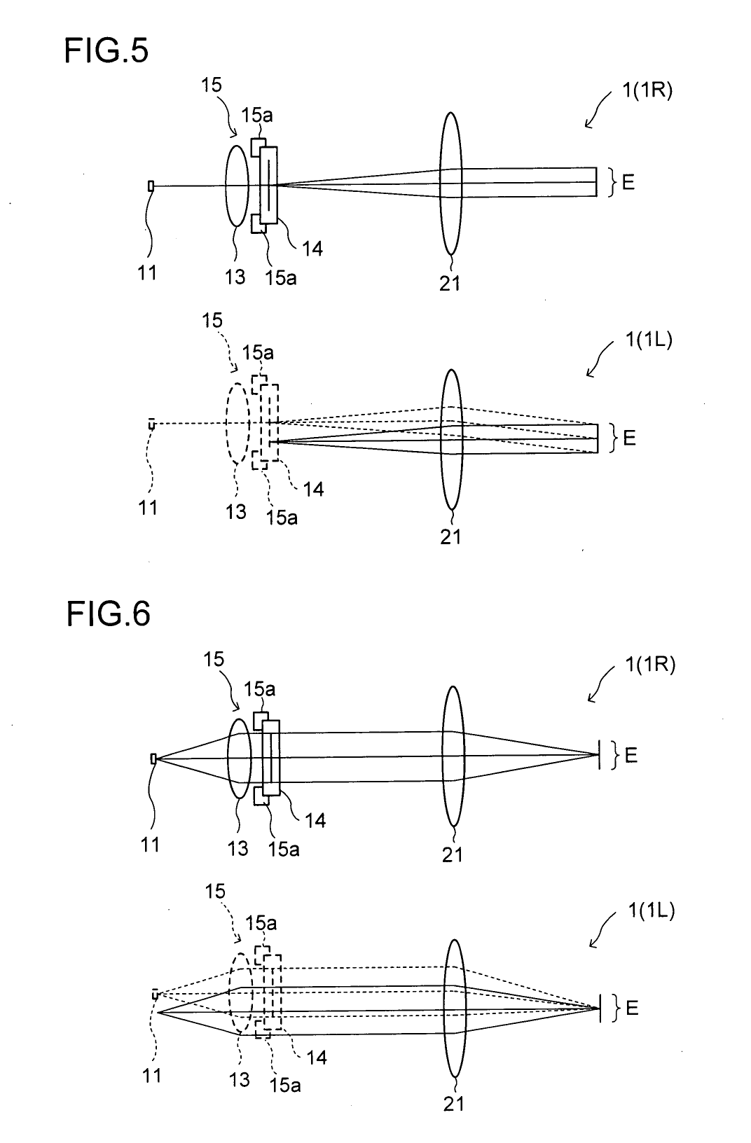

The component members may be arranged such that the light emitted from the light source 11 turns into parallel light upon the passage through the display device 14. FIG. 5 is an explanatory diagram showing expanded optical paths of light exiting from the centers of the display regions of the display devices 14 in the image display apparatuses 1R and 1L in each of which the light source 11 is arranged at the focal position of the condensing lens 13. FIG. 6 is an explanatory diagram showing expanded optical paths of light exiting from the light sources 11 of the image display apparatuses 1R and 1L with the configuration of FIG. 5. In these figures, solid lines indicate an optical path before optical axis adjustment, and broken lines indicate an optical path after the optical axis adjustment.

When the display device 14 is illuminated by parallel light, the light source 11 and the condensing lens 13 can be integrated together with the display device 14 and they can be moved in the direction intersecting the optical axis relative to the ocular optical system 21 to thereby perform optical axis adjustment without changing the position of the optical pupil E relative to the ocular optical system 21. Therefore, even in this case, the image luminance deterioration and image quality degradation caused by the optical axis adjustment can be avoided.

Only the display device 14 may be moved in the direction intersecting the optical axis to thereby perform the optical axis adjustment without changing the position of the optical pupil E relative to the ocular optical system 21. As described above, the configuration such that the light source 11 and the condensing lens 13 are integrated together with the display device 14 and they are integrally moved is limited in the degree of freedom in optical design. Therefore, in this regard, configuration such that only the display device 14 is moved to perform the optical axis adjustment is preferable.

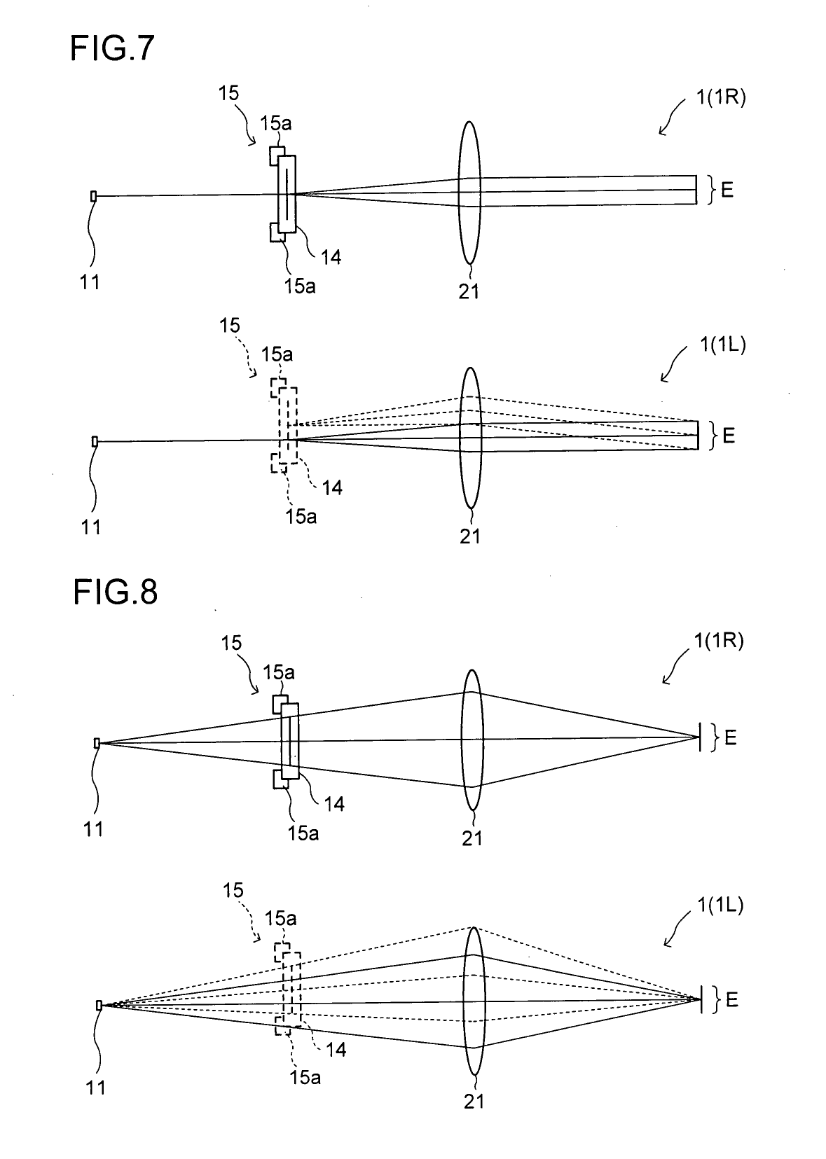

FIG. 7 is an explanatory diagram showing expanded optical paths of light exiting from the centers of the display regions of the display devices 14 in the image display apparatuses 1R and 1L in each of which the condensing lens 13 is not provided and the light source 11 directly illuminates the display device 14. FIG. 8 is an explanatory diagram showing expanded optical paths of light emitted from the light sources 11 of the image display apparatuses 1R and 1L with the configuration of FIG. 7. In these figures, solid lines indicate an optical path before optical axis adjustment, and broken lines indicate an optical path after the optical axis adjustment.

With this configuration, unlike in FIGS. 1 through 6, the condensing lens 13 is not provided on the optical path, thus permitting formation of the apparatus at low costs. Moreover, the light from the light source 11 is not condensed by the condensing lens 13; thus, compared to the configuration of FIGS. 1 through 6, an observed image is a little darker, an interval between the light source 11 and the display device 14 is longer due to the arrangement of the light source 11 and the optical pupil E such that they are substantially conjugate with each other, and the apparatus is a little larger. However, this configuration is not at all different from the configuration of FIGS. 1 through 6 in that the display device 14 can be moved relative to the ocular optical system 21 in the direction intersecting the optical axis to thereby perform optical axis adjustment without changing the position of the optical pupil E relative to the ocular optical system 21. Therefore, even with the configuration of FIG. 7 and FIG. 8, the image luminance deterioration and image quality degradation caused by the optical axis adjustment can be avoided.

### Second Embodiment

Another embodiment of the present invention will be described below, with reference to the accompanying drawings. For explanatory purposes, members with the same configuration as those in the first embodiment are provided with the same numerals. The configuration not mentioned in the first embodiment will be described as appropriate. Basic configuration of the image display apparatus 1 of the present embodiment is the same as that of the first embodiment, and is a more detailed version of the first embodiment.

### (1. Configuration of the Image Display Apparatus)

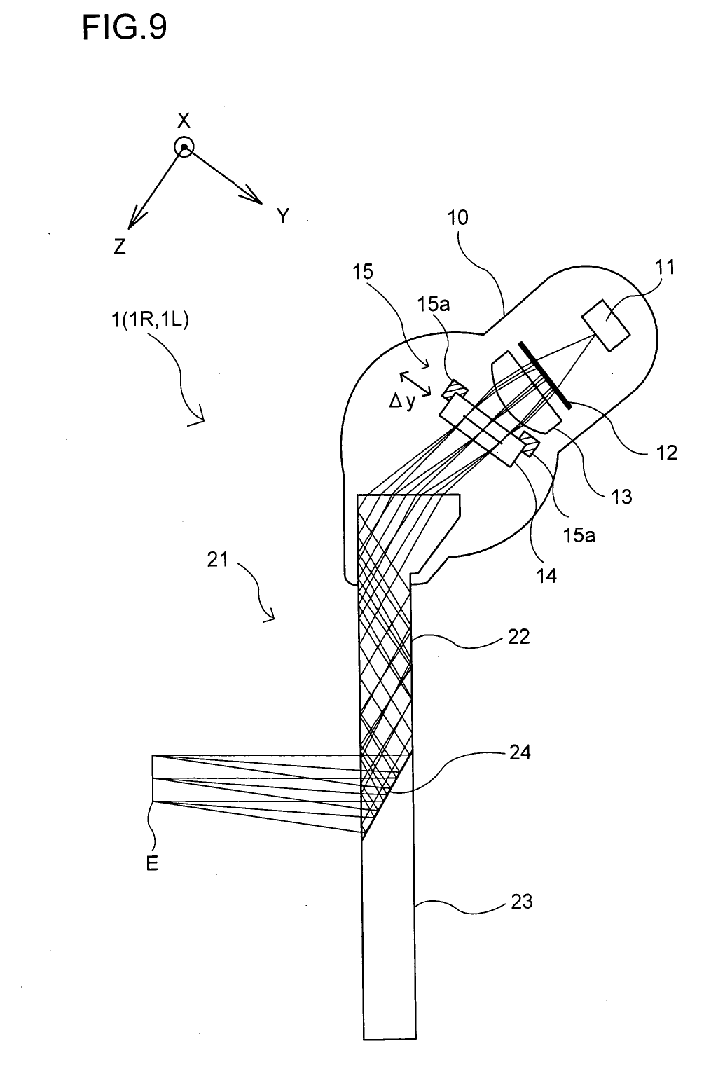

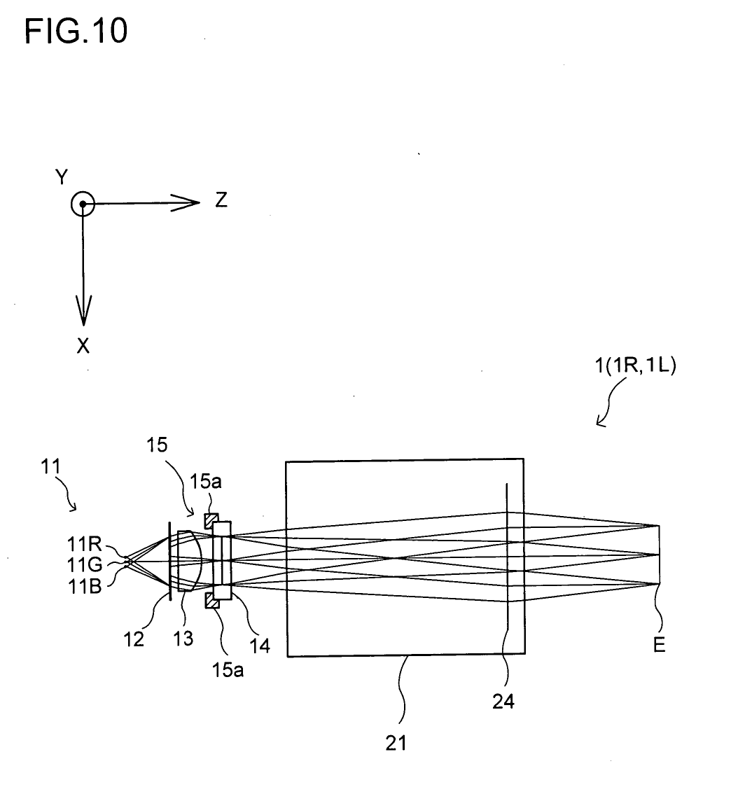

FIG. 9 is a sectional view showing general configuration of the image display apparatus 1 (the image display apparatuses 1R and 1L). FIG. 10 is an explanatory diagram showing an optical path optically expanded in one direction in the image display apparatuses 1R and 1L. The image display apparatuses 1R and 1L each have a light source 11, a one direction diffuser plate 12, a condensing lens 13, a display device 14, an optical axis adjustment mechanism 15, and an ocular optical system 21. As shown in FIG. 9, the light source 11, the one direction diffuser plate 12, the condensing lens 13, and the display device 14 are stored in a case 10, and part of the ocular optical system 21 (part of an ocular prism 22 to be described later) is located in the case 10.

Here, for explanatory purposes below, a direction is defined as follows. First, an axis optically linking together the center of a display region of the display device 14 and the designed center of an optical pupil E formed by the ocular optical system 21 is an optical axis (in the second embodiment, a principal point can not be clarified since an axis-asymmetric optical system is used, which changes the definition of the optical axis). An optical axis direction when the optical path from the light source 11 to the optical pupil E is expanded is a Z direction. A direction vertical to an incidence plane along which the optical axis runs onto a hologram optical element 24, which will be described later, provided in the ocular optical system 21 is an X direction, and a direction vertical to a ZX plane is a Y direction. The incidence plane along which the optical axis runs onto a hologram optical element 24 indicates a plane including the optical axis of light entering the hologram optical element 24 and the optical axis of light reflected by the hologram optical element 24, that is, a YZ plane. Hereinafter, the incidence plane described above is simply referred to as an incidence plane or an optical axis incidence plane.

The light source 11 in the present embodiment is formed of an RGB-unified type LED (for example, manufactured by Nichia Corporation) having as light emitting parts 11R, 11G, and 11B (see FIG. 10) three light emitting chips emitting light of wavelengths respectively corresponding to three primary colors, red (R), green (G), and blue (B). The light emitting parts 11R, 11G, and 11B are arranged alongside the X direction, the direction in which diffusion by the one direction diffuser plate 12 is large (see FIG. 10). Consequently, intensity nonuniformity among the different colors on the optical pupil E is small, thus permitting reducing color unevenness.

The LED is low-price and compact, and has high color purity since the light emission wavelength width is narrow as described later. Therefore, forming the light source 11 with the LED permits providing a low-price, compact image display apparatus and also permits providing an image with high color purity to an observer.

The one direction diffuser plate 12 diffuses light emitted from the light source 11, and its degree of diffusion differs among the different directions. More in detail, the one direction diffuser plate 12 diffuses incident light in the X direction at approximately 40 degrees, and diffuses incident light in the Y direction at approximately 0.5 degrees. The one direction diffuser plate 12 has a surface on the light source 11 side provided as an optically flat surface and a surface on the condensing lens 13 side provided as an uneven surface which performs diffusion by its unevenness. Therefore, divergent light from the light source 11 is diffused in such a manner as to be refracted by the flat surface of the one direction diffuser plate 12 and thus slightly condensed, so that the condensed state is a little saved. Therefore, the one direction diffuser plate 12 has more or less a function as a convex lens, and light entering the one direction diffuser plate 12 is slightly refracted in the direction required for the formation of the optical pupil E.

The condensing lens 13 is an illumination optical system which condenses light from the light source 11 and then guides the light to the display device 14. This condensing lens 13 is formed of a cylinder lens which condenses in the Y direction light diffused by the one direction diffuser plate 12, and arranged so that this diffused light efficiently forms the optical pupil E. In the present embodiment, the optical pupil E is sized 6 mm in the X direction and 2 mm in the Y direction. As just mentioned, the optical pupil E is sized 6 mm in one direction (X direction), which is larger than the size of the human pupil (approximately 3 mm), thus making it easy for the observer to observe an image. On the other hand, the optical pupil E is sized 2 mm in a different direction (Y direction), which is smaller than the size of the human pupil, so that the light from the light source 11 is condensed on the optical pupil E in the aforementioned direction without loss. This permits the observer to observe a bright image.

The display device 14 modulates light emitted from the light source 11 in accordance with image data to display an image, and is formed of a transmissive liquid crystal display device having in a matrix form pixels each serving as a region through which light is transmitted. Each of the pixels of the display device 14 is provided with color filters (transparent wavelength restricting filters) which restrict transmission of light emitted from the light source 11 in accordance with the wavelength of the aforementioned light. The color filters includes three types of filters respectively corresponding to the three primary colors, each transmitting, of light emitted from the light source 11, the light of any one of the wavelengths respectively corresponding to the three RGB primary colors while restricting transmission of the remaining light.

As described above, the display device 14 has the color filters, and can modulate the light from the light source 11 in accordance with image data and make the light exit via the color filters to thereby display a color image. The display device 14 is arranged such that a longer direction of the rectangular display region is an X direction and a shorter direction thereof is a Y direction.

The ocular optical system 21 is an observation optical system which guides light of an image displayed on the display device 14 to the pupil of an observer (or the optical pupil E), and has the ocular prism 22 (first transparent substrate), a deflecting prism 23 (second transparent substrate), and the hologram optical element 24.

The ocular prism 22 totally reflects therein image light from the display device 14 and then guides the image light to the pupil of the observer via the hologram optical element 24 while transmitting external light and then guiding the external light to the pupil of the observer, and is formed of, for example, acrylic resin together with the deflecting prism 23. This ocular prism 22 is wedge-shaped so that a lower end part of a parallel plate is formed thinner toward the lower end, and shaped so that the upper end part thereof is formed thicker toward the upper end. The ocular prism 22 is joined together to the deflecting prism 23 with an adhesive agent in such a manner as to sandwich with the deflecting prism 23 the hologram optical element 24 arranged at the lower end part thereof.

The deflecting prism 23 is formed of a parallel plate which is substantially U-shaped in a plan view, and is integrated with the ocular prism 22 when attached together with the lower end part and both side surfaces parts (right and left end surfaces) of the ocular prism 22 thereby forming a substantially parallel plate. Joining this deflecting prism 23 to the ocular prism 22 permits avoiding occurrence of distortion in an outside image observed via the ocular optical system 21 by the observer.

Specifically, for example, when the ocular prism 22 is not joined to the deflecting prism 23, external light is refracted when transmitted through the wedge-shaped lower end part of the ocular prism 22, thus causing distortion in an outside image observed via the ocular prism 22. However, joining the deflecting prism 23 to the ocular prism 22 to form an integral, substantially parallel plate can cancel by the deflecting prism 23 the refraction of the external light when transmitted through the wedge-shaped lower end part of the ocular prism 22. As a result, occurrence of distortion in the outside image observed in a see-through manner can be avoided.

Surfaces (light incidence surfaces and light exit surface) of the ocular prism 22 and the deflecting prism 23 may be a flat surface or any of curved surfaces (including an aspherical surface, curvature, and a spherical surface). Forming the surfaces of the ocular prism 22 and the deflecting prism 23 into curvature permits providing the ocular optical system 21 with function as a correcting glass lens.

The hologram optical element 24 is a volume phase type, reflective hologram which diffracts image light exiting from the display device 14 (light of the wavelengths respectively corresponding to the three primary colors), enlarges the image displayed on the display device 14, and then guides the image to the pupil of the observer as a virtual image, and has an axis-asymmetric positive optical power. That is, the hologram optical element 24 has the same function as that of an aspherical concave mirror having a positive power. This permits improving the degree of freedom in arrangement of the optical members forming the apparatus, thus easily downsizing the apparatus, and also permits providing to the observer an image in which aberration has been favorably corrected. Moreover, the hologram optical element 24 functions as a combiner which simultaneously guides image light from the display device 14 and external light to the pupil of the observer, so that the observer can simultaneously observe the image from the display device 14 and the outside image via the hologram optical element 24. A method of fabricating the hologram optical element 24 in the present embodiment will be described later.

### (2. Operation of the Image Display Apparatus)

Next, the operation of the image display apparatus 1 with the configuration described above will be described. Light emitted from the light source 11 is diffused by the one direction diffuser plate 12, condensed by the condensing lens 13, and then enters the display device 14. The light entering the display device 14 is modulated for each of the pixels based on image data and then exits as image light via the color filters. That is, the display device 14 displays a color image.

The image light from the display device 14 enters into the ocular prism 22 of the ocular optical system 21 through the upper end surface thereof, is totally reflected a plural number of times by the opposing two surfaces, and then enters the hologram optical element 24. The light entering the hologram optical element 24 is diffracted and reflected thereon and then reaches the optical pupil E. At the position of the optical pupil E, the observer can observe an enlarged virtual image of the image displayed on the display device 14.

On the other hand, the ocular prism 22 and the deflecting prism 23 transmit almost all of external light, so that the observer can observe outside image. Therefore, the virtual image of the image displayed on the display device 14, being partially superimposed on the outside image, is consequently observed.

As described above, the image display apparatus 1 is configured such that image light exiting from the display device 14 is guided to the hologram optical element 24 through the total reflection in the ocular prism 22. Thus, as is the case with a normal eye-glass lens, the ocular prism 22 and the deflecting prism 23 can be formed into a thickness of approximately 3 mm, thus permitting downsizing and weight reduction of the image display apparatus 1. Moreover, the use of the ocular prism 22 which totally reflects therein the image light from the display device 14 permits ensuring high transmittance of external light, thus providing a bright outside image to the observer.

### (3. Optical Axis Adjustment)

Also in the present embodiment, as in the first embodiment, the optical axis adjustment mechanism 15 adjusts the position of the display device 14 relative to the ocular optical system 21 in the direction intersecting the optical axis to thereby change relative positional relationship between an image displayed on the display device 14 and the ocular optical system 21. Thus, the optical axis adjustment mechanism 15 is provided near the display device 14 in the case 10. The optical axis adjustment mechanism 15 has a holding part 15a which holds the display device 14. Thus, there are provided two holding parts 15a along the Y direction, and the holding parts 15a are capable of sliding in the direction intersecting the optical axis (here, direction substantially parallel to the display plane of the display device 14 (XY plane)) while holding the display device 14.

In the present embodiment, as in the first embodiment, the light source 11 is so arranged as to be substantially conjugated with the optical pupil E by the condensing lens 13 and the ocular optical system 21. Therefore, the holding part 15a can be slid by, for example, Δy in the direction described above to adjust the position of the display device 14 and then the holding part 15a can be fixed to the case 10 to thereby perform optical axis adjustment without changing the position of the optical pupil E relative to the ocular optical system 21. As a result, as in the first embodiment, the image luminance deterioration and image quality degradation caused by the optical axis adjustment can be avoided.

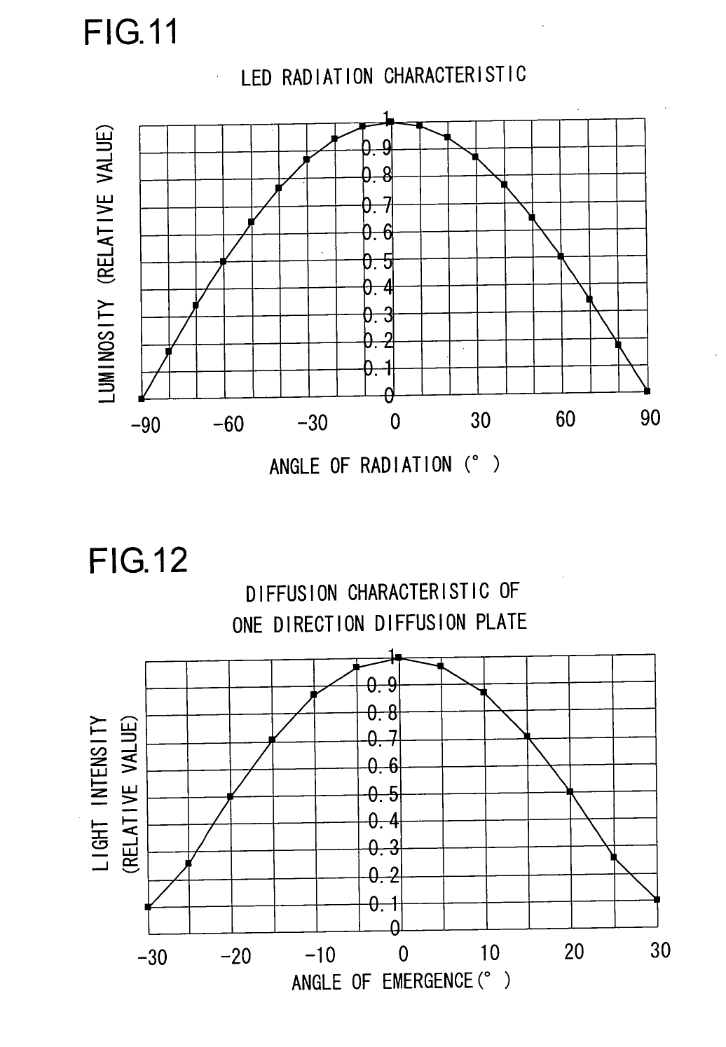

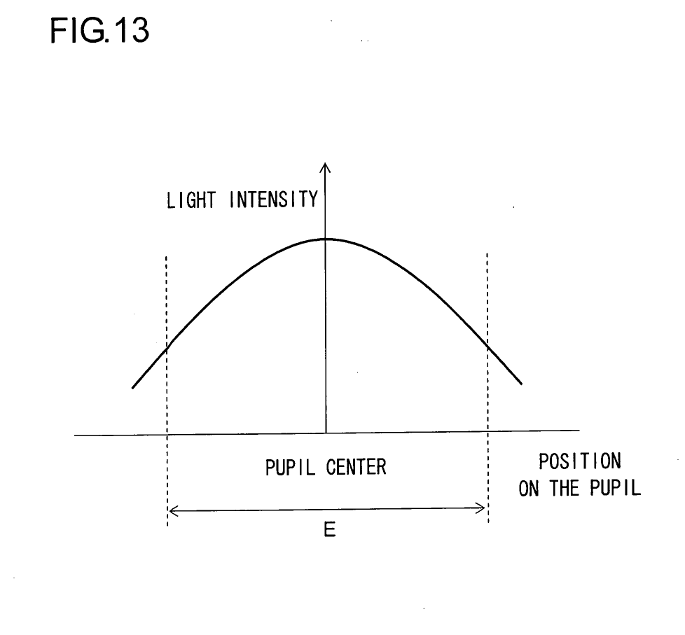

In particular, in the present embodiment, the one direction diffuser plate 12 is used. Considering both a radiation characteristic of the light source 11 and a diffusion characteristic of the one direction diffuser plate 12, it is optically designed such that the light intensity is high at the position of the optical pupil E before optical axis adjustment. Here, FIG. 11 is a graph showing the radiation characteristic of the RGB LED forming the light source 11 (relationship between radiation angles and luminosities). FIG. 12 is a graph showing the diffusion characteristic of the one direction diffuser plate 12 (relationship between angles of emergence and light intensities). FIG. 13 is an explanatory diagram showing light intensity distribution (luminance distribution) for a given wavelength (for example, R light) at the position of the optical pupil E before the optical axis adjustment.

As described above, even when, considering the radiation characteristic of the light source 11 and the diffusion characteristic of the one direction diffuser plate 12, the image display apparatus 1 is designed such that the light intensity is high at the position of the optical pupil E before the optical axis adjustment, the optical axis adjustment mechanism 15 can perform the optical axis adjustment without changing the position of the optical pupil E relative to the ocular optical system 21, thus achieving, even after the optical axis adjustment, light intensity at the position of the optical pupil E where this light intensity is designed to be high. Therefore, luminance deterioration of an image observed at the position of the optical pupil E caused by the optical axis adjustment can be avoided.

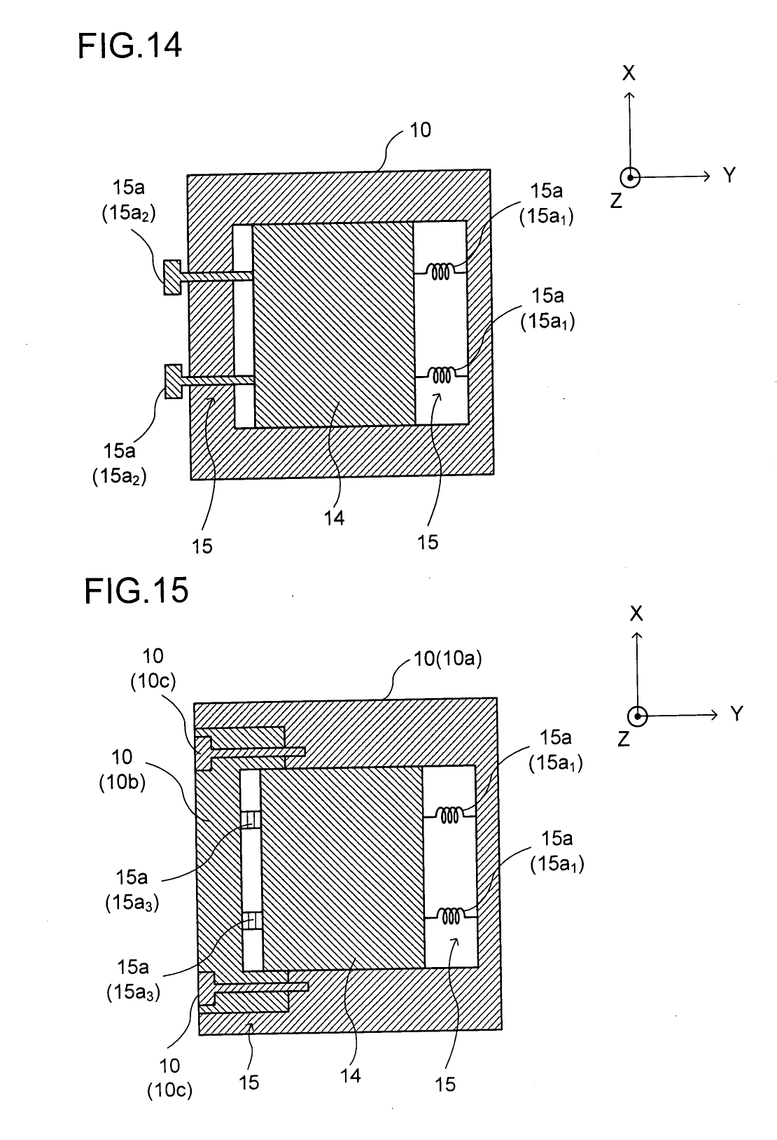

The optical axis adjustment mechanism 15 may be configured in the following manner. FIG. 14 is a sectionional view as viewed along the optical axis showing another configuration example of the optical axis mechanism 15. This optical axis adjustment mechanism 15 has two holding parts 15a provided along the Y direction, one of which is formed of two springs 15a₁ arranged in parallel and another one of which is formed of two screws 15a₂ arranged in parallel. As a result, the display device 14 has one end side thereof coupled to the case 10 via the springs 15a₁ and another end side thereof fixed to the case 10 via the screws 15a₂. The screws 15a₂ are so provided as to penetrate through the case 10, so that the screws 15a₂ can be turned from the outer side and moved back and force in the Y direction. Note that the numbers of springs 15a₁ and screws 15a₂ are not limited to two described above.

With this configuration, the display device 14 is biased in the Y direction (from the spring 15a₁ side toward the screw 15a₂ side in particular) by the springs 15a₁ with the case 10 serving as a support. Thus, displacement of the screws 15a₂ in the Y direction relative to the case 10 by way of turning the screws 15a₂ permits adjustment of an interval in the Y direction between the case 10 and the display device 14, which in turn permits adjustment of the position of the display device 14 in the Y direction relative to the case 10.

Therefore, the optical axis adjustment mechanism 15 of FIG. 14 can be said to be configured in the following manner. Specifically, the optical axis adjustment mechanism 15 includes the holding parts 15a holding the display device 14 in the case 10. These holding parts 15a include: (1) biasing means (springs 15a₁) which bias one end of the display device 14 in the direction intersecting the optical axis (Y direction here) with the case 10 serving as a support; and (2) position adjustment members (screws 15a₂) which are so provided as to penetrate through the case 10 in the aforementioned direction, which make contact with another end of the display device in the aforementioned direction, and which move back and forth in the aforementioned direction relative to the case 10 to thereby adjust the position of the display device 14 relative to the case 10.

FIG. 15 is a sectional view as viewed along the optical axis showing still another configuration example of the optical axis adjustment mechanism 15. This optical axis adjustment mechanism 15 has two holding parts 15a provided along the Y direction, one of which is formed of the springs 15a₁ described above and another one of which is formed of spacers 15a₃ of a predetermined width. In this condition, the case 10 is composed of: a main body 10a; a lid 10b which is detachable from the main body 10a; and screws 10c (fixing member) for fixing the lid 10b to the main body 10a. The lid 10b can be detached from the main body 10a by turing these screws 10c, then closed by hitching the spacers 15a₃ of a predetermined width on the under side of the lid 10b (display device 14 side), and then fixed to the main body 10a with the screw 10c to thereby ensure an interval between the lid 10b and the disiplay device 14 equivalent to the width of the spacer 15a₃.

Under the condition that the spacers 15a₃ are placed inside the case 10 in this manner, one end side of the display device 14 in the Y direction is coupled to the main body 10a via the springs 15a₁ and another end side thereof is coupled to the lid 10b via the spacers 15a₃. Moreover, the display device 14 is biased in the Y direction (from the spring 15a₁ side toward the spacer 15a₃ side in particular) by the springs 15a₁ with the case 10 serving as a support. Consequently, the width of the spacers 15a₃ inserted between the lid 10b and the display device 14 is changed; that is, spacers a₃ of an appropriate width can be selected and inserted between the lid 10b and the display device 14 to thereby adjust the interval in the Y direction between the lid 10b and the display device 14. As a result, the position of the display device 14 can be adjusted in the Y direction relative to the main body 10a.

Therefore, the optical axis adjustment mechanism 15 of FIG. 15 can be said to be configured in the following manner. Specifically, the optical axis adjustment mechanism 15 includes the holding parts 15a holding the display device 14 in the case 10. These holding parts 15a include: (1) the biasing means (springs 15a₃) which bias one end of the display device 14 in the direction intersecting the optical axis (Y direction here) with the case 10 serving as a support; and (2) insertion members (spacers 15a₃) which are inserted between the lid 10b of the case 10 and another end of the display device 14 in the aforementioned direction. The position of the display device 14 in the case 10 in the aforementioned direction is adjusted in accordance with the width of the insertion members in the aforementioned direction.

Instead of the spacers 15a₃ of a predetermined width, a washer of a predetermined width may be used and the number of the washers may be changed to adjust the interval between the lid 10b and the display device 14 in the aforementioned direction to thereby adjust the position of the display device 14 in the case 10 in the aforementioned direction.

### (4. Method of Fabricating the Hologram Optical Element)

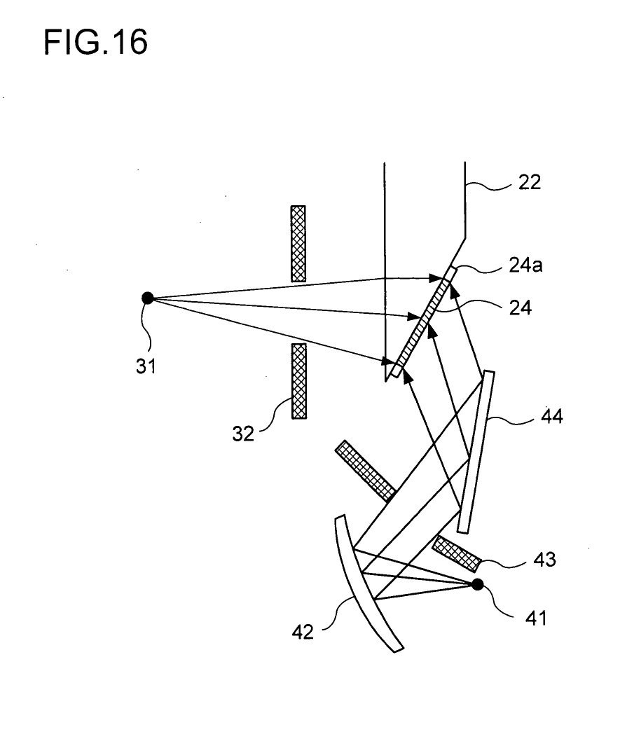

Next, the method of fabricating the hologram optical element 24 of the present embodiment will be briefly described below. FIG. 16 is a sectional view showing schematic configuration of an optical system used for fabricating the hologram optical element 24.

First, a hologram photosensitive material 24a is applied to a surface of the ocular prism 22 attached to the deflecting prism 23. Here, the hologram photosensitive material 24a is applied to the ocular prism 22 over a wider range than the irradiation range of two beams used upon the fabrication. Then, the ocular prism 22 with the hologram photosensitive material 24a applied thereto is arranged at a predetermined position of the optical system shown in FIG. 16.

In the optical system described above, laser light from a light source, not shown, diverges into two beams, and converted into point light sources 31 and 41, respectively, emitting light of three RGB colors. The light emitted from the point light source 31 (one of the two beams used upon the fabrication) is irradiated to the hologram photosensitive material 24a from the rear side thereof (on the ocular prism 22 side) via an aperture stop 32. The range in which the emitted light is irradiated to the hologram photosensitive material 24a is a range that permits diffracting, of light irradiated upon reproduction of the fabricated hologram optical element 24, only the central beam of light having favorable optical performance.

On the other hand, the light emitted from the point light source 41 is irradiated via a production optical system 42, an aperture stop 43, and a reflective mirror 44 in the order just mentioned to the hologram photosensitive material 24a from the front surface side thereof (side opposite to the ocular prism 22). The irradiation of the emitted light to the hologram photosensitive material 24a via the production optical system 42 permits providing the formed hologram optical element 24 with an axis-asymmetric positive power. The range in which the emitted light is irradiated to the hologram photosensitive material 24a permits diffracting, of light irradiated upon reproduction of the fabricated hologram optical element 24, only the central beam of light having favorable optical performance.

As a result of the irradiation of these two beams, interference fringe is recorded on a portion where the irradiation ranges of the two beams in the hologram photosensitive material 24a are superimposed on each other, thus fabricating the hologram optical element 24 . Thereafter, baking processing and fixation processing are performed, and then the ocular prism 22 with the hologram optical element 24 formed thereon and the deflecting prism 23 (see FIG. 9) are attached together, thereby completing the ocular optical system 21.

In the optical system described above, numeric apertures (beam diameters of the emitted light) of the point light sources 31 and 41 are restricted by the aperture stops 32 and 43. Thus, the two beams used upon the fabrication can be sized equally on the hologram photosensitive material 24a, and the hologram optical element 24 can be fabricated only in the range where, of the light irradiated upon the reproduction of the hologram optical element 24, the central beam having favorable optical performance is irradiated. Moreover, the two beams used upon the fabrication interfere in the same range. Thus, interference by only one laser light is less likely to occur, so that unnecessary interference fringe is not recorded on the hologram photosensitive material 24a. Therefore, the hologram optical element 24 having favorable optical performance and less likely to cause flare and ghost can be fabricated, thus providing an image with high quality to the observer.

Further, the two beams used upon the fabrication are formed by restricting divergence angles of the light emitted from the corresponding point light sources 31 and 41 by the aperture stops 32 and 43, thus permitting easy, reliable, and low-cost control of the size of the hologram optical element 24 on the ocular prism 22.

The point light source 31 is arranged near the optical pupil E. Bringing the position of the point light source 31 at the time of the fabrication of the hologram optical element 24 substantially in agreement with the position of the optical pupil E in this manner permits providing the same image display colors without depending on the position of the screen. That is, when the same color is displayed on the entire display screen of the display device 14, the color of an image observed at the position of the optical pupil E does not vary depending on the position of the display screen.

The wavelength of light diffracted by the hologram optical element 24 and then reaching the optical pupil E upon the reproduction varies depending on the position of the optical pupil E. However, in the present embodiment, the optical axis adjustment mechanism 15 performs optical axis adjustment without changing the position of the optical pupil E relative to the ocular optical system 21, thus permitting maintaining favorable color reproducibility without changing the wavelength of the light reaching the optical pupil E through the optical axis adjustment.

Contrarily, adjusting the position of the optical pupil E permits adjustment of the wavelength of the light reaching the optical pupil E, which will be described later.

### (5. Effect of Widening the Color Reproduction Region)

In the present embodiment, appropriately setting characteristics of the light source 11 and the hologram optical element 24 permits widening the color reproduction region of an image (virtual image) displayed by the image display apparatus 1, which will be described below.

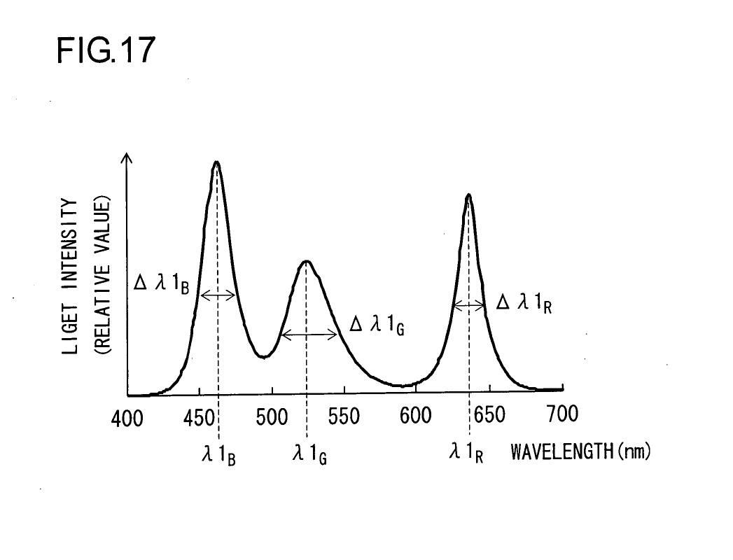

FIG. 17 is an explanatory diagram showing spectral intensity distribution of the light source 11, that is, relationship between wavelengths and light intensities of emitted light. The light source 11 is, for example, an RGB-unified LED (for example, manufactured by Nichia Corporation) which emits light of three wavelength widths, 462±12 nm, 525±17 nm, and 635±11 nm, with peak-light-intensity wavelengths and half-light intensity wavelength widths. Here, the peak-light-intensity wavelength is a wavelength with which the light intensity becomes peak, and the half-light-intensity wavelength width is a wavelength width with which the light intensity becomes half of the peak light intensity. FIG. 17 shows the light intensities with relative values where the maximum light intensity of the B light is 100.

Specifically, in the present embodiment, where the peak-light-intensity wavelengths of BGR in the light source 11 are defined as λ1_{B}, λ1_{G}, and λ1_{R}, respectively, λ1_{B} is 462 nm, λ1_{G} is 525 nm, and λ1_{R} is 635 nm. Where the half-light-intensity wavelength widths of the BGR in the light source 11 are defined as Δλ1_{B}, Δλ1_{G}, and Δλ1_{R}, respectively, λ1_{B} is 24 nm, Δλ1_{G} is 34 nm, and Δλ1_{R} is 22 nm.

The light intensities of the RGB of the light source 11 are adjusted, considering the diffraction efficiency of the hologram optical element 24 and light transmittance of the display device 14, thereby permitting white color display.

As described above, the light source 11 emits light having a plurality of wavelengths with which the light intensity becomes peak. Thus, light from the light source 11 can be modulated by the display device 14 and then guided via the ocular optical system 21 to the pupil of the observer, thereby permitting the observer to observe a color image.

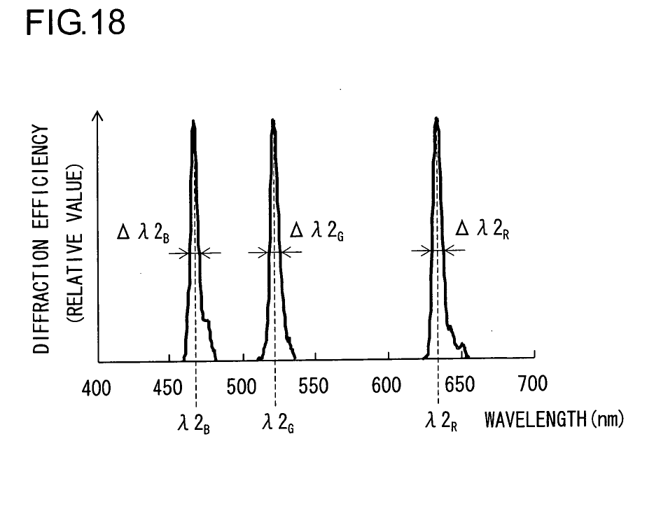

On the other hand, FIG. 18 is an explanatory diagram showing dependence of the diffraction efficiency on wavelengths in the hologram optical element 24. As shown in FIG. 18, the hologram optical element 24 is, for example, so fabricated as to diffract (reflect) light of three wavelength widths, 465±5 nm (B light), 521±5 nm (G light), and 634±5 nm (R light), with peak-diffraction-efficiency wavelengths and half-diffraction-efficiency wavelength widths. Here, the peak-diffraction-efficiency wavelength is a wavelength with which the diffraction efficiency becomes peak, and the half-diffraction-efficiency wavelength width is a wavelength width with which the diffraction efficiency becomes half of the peak diffraction efficiency. FIG. 18 shows the diffraction efficiencies by relative values where the maximum diffraction efficiency of the B light is 100.

Specifically, in the hologram optical element 24 of the present embodiment, the peak-diffraction-efficiency wavelength λ2_{B} of the B light is 465 nm, the peak-diffraction-efficiency wavelength Δ2_{G} of the G light is 521 nm, and the peak-diffraction-efficiency wavelength λ2_{R} of the R light is 634 nm. In the hologram optical element 24, the half-diffraction-efficiency wavelength width Δλ2_{G} of the B light is 10 nm, the half-diffraction-efficiency wavelength width Δλ2_{G} of the G light is 10 nm, and the half-diffraction-efficiency wavelength width Δλ2_{R} of the R light is 10 nm.

The hologram optical element 24 is so fabricated as to diffract only light of a particular wavelength at a particular angle of incidence, thus having almost no effect on the transmission of external light. Therefore, the observer can view an outside image as usual via the ocular prism 22, the hologram optical element 24 and the deflecting prism 23. Moreover, the half-diffraction-efficiency wavelength width Δλ2 of the hologram optical element 24 is as narrow as 10 nm, so that the observer can observe a bright image. In addition, the transmittance of outside light is high, so that the observer can observe a bright outside image. Such effect can be provided if Δλ2 for each of the RGB light is between 5 nm inclusive and 10 nm inclusive.

In the present embodiment, the half-light-intensity wavelength widths Δλ1 (Δλ1_{B}, Δλ1_{G}, and Δλ1_{R}) of the BGR in the light source 11 are as wide as 20 nm or more; thus, setting the half-diffraction-efficiency wavelength widths Δλ2 (Δλ2_{B}, Δλ2_{G}, and Δλ2_{R}) of the respective BGR colors in the hologram optical element 24 at less than 20 nm (providing Δλ1>Δλ2) permits improving the BGR color purities, thus widening the color reproduction region of an observed image.

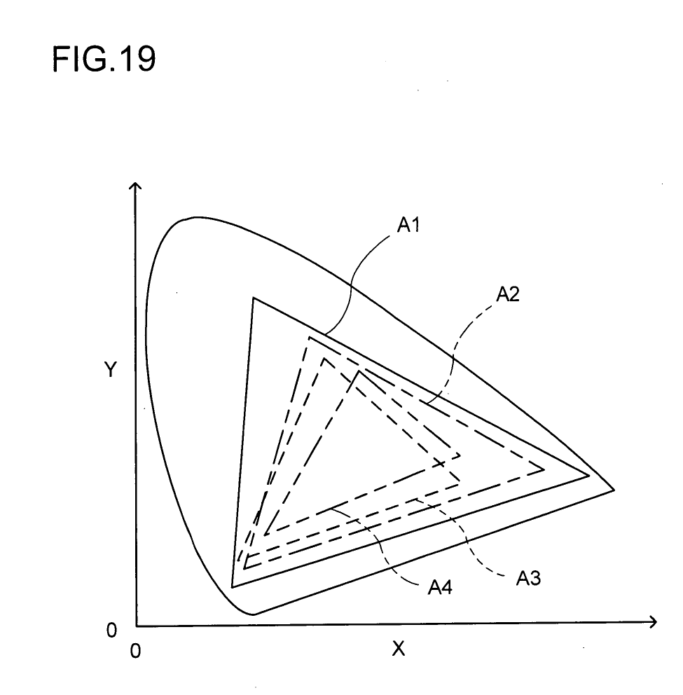

Here, FIG. 19 shows color reproduction regions of a virtual image expressed by using XY chromaticity coordinates in a XYZ color coordinate system. In FIG. 19, a solid line A1 indicates the color reproduction region in the image display apparatus 1 of the present embodiment, that is, the image display apparatus having the display device 14 with the color filters, the hologram optical element 24, and the light source 11 formed of the RGB-unified 3-in-1 LED. A dashed line A2 indicates the color reproduction region in an image display apparatus having a display device 14 with color filters, a hologram optical element 24, and a white light source (white LED). The aforementioned image display apparatus is also an image display apparatus of the fourth embodiment to be described later.

On the other hand, a broken line A3 indicates the color reproduction region in an image display apparatus having a display device 14 having color filters, an ocular optical system not using the hologram optical element 24, and a light source 11 formed of an RGB-unified 3-in-1 LED. A chain dashed line A4 indicates the color reproduction region in an image display apparatus having a display device 14 having color filters, an ocular optical system not using the hologram optical element 24, and a white light source (white LED). As the ocular optical system not using the hologram optical element 24, there is provided, for example, a free-curved surface prism.

According to FIG. 19, the color reproduction regions have the solid line A1 and dashed line A2 wider than the broken line A3 and the chain dashed line A4. Thus, use of the hologram optical element 24 whose half-diffraction-efficiency wavelength width Δλ2 is approximately 10 mm permits improving the color purity, thus widening the color reproduction regions. In particular, as shown by the solid line A1, the use of the RGB-unified type as the light source 11 permits providing a wider color reproduction region than is provided in a case where the light source 11 is formed of a white light source.

### (6. Effect of Reducing Color Unevenness)

In the present embodiment, the optical pupil E is so set as to be sized 6 mm in the X direction and 2 mm in the Y direction at a half intensity, as described above. That is, the optical pupil E is larger in the X direction, that is, in the direction vertical to the incidence plane (YZ plane) along which the optical axis enters runs onto the hologram optical element 24 than in the Y direction, that is, the direction parallel to the incidence plane. Setting the sizes of the optical pupil E in this manner permits the observer to observe an image with high image quality and less color unevenness under little influence of a wavelength characteristic (wavelength selectivity) of the hologram optical element 24, reasons of which will be described below.

First, relationship between the angles of incidence and the wavelength selectivity in the hologram optical element 24 will be described. In the hologram optical element 24 having interference fringe which diffracts light having an angle of incidence of more than 0 degrees, the wavelength selectivity is smaller in the direction vertical to the incidence plane than in the direction parallel to the incidence plane (shift in the diffracted wavelength due to shift in the angle of incidence is smaller). In other word, the angle selectivity for shift in the angle of incidence on the interference fringe is lower in the direction vertical to the incidence plane than in the direction parallel to the incidence plane. This is because, when light enters the interference fringe of the hologram optical element 24 at some angle of incidence, shift in the angle of incidence within the incidence plane (YZ plane) directly becomes shift in the angle of incidence, having great influence on the diffracted wavelengths, while the angle shift in the direction vertical to the incidence plane is small as the shift in the angle of incidence, having small influence on the diffracted wavelengths.

Therefore, when light enters the interference fringe of the hologram optical element 24 at an angle shifted from a predetermined angle of incidence, angle shift in the direction parallel to the incidence plane results in larger shift in the diffracted wavelengths than angle shift in the direction vertical to the incidence plane (that is, the wavelength selectivity is larger in the direction parallel to the incidence plane).

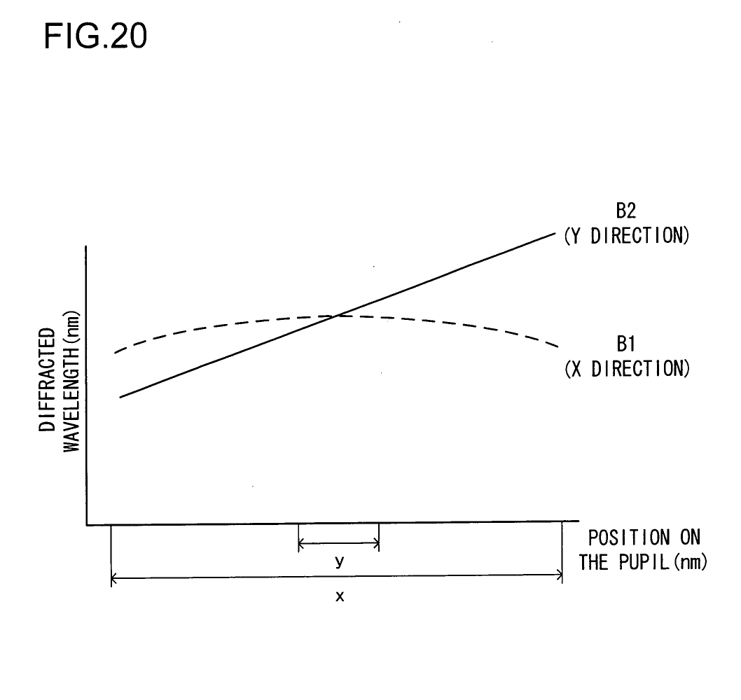

Here, FIG. 20 is an explanatory diagram showing relationship between the pupil position in the optical pupil E and main diffracted wavelengths (for example, R light) in the present embodiment. In FIG. 20, a broken line B1 indicates change in the diffracted wavelength in the X direction of the optical pupil E, and a solid line B2 indicates change in the diffracted wavelength in the Y direction of the optical pupil E. As described above, the change in the diffracted wavelength is larger in the Y direction parallel to the incidence plane than in the X direction vertical to the incidence plane.

Therefore, forming a small optical pupil E in the Y direction where the change in the diffracted wavelength is larger narrows down the range of change in the diffracted wavelength, which permits reducing color unevenness on the optical pupil E. Moreover, forming a large optical pupil E in the direction vertical to the incidence plane also permits providing an image with high color purity to the observer.

An incidence plane for light outside the optical axis incidence plane is a little not parallel to the optical axis incidence plane; however, as described above, the angle shift in the direction vertical to the incidence plane has smaller influence on the diffracted wavelength, so that the color unevenness does not become greater even when compared to the optical axis incidence plane as a reference.

The light from the light source 11 is diffused in the X direction vertical to the optical axis incidence plane by the one direction diffuser plate 12, and thus the light source 11 is not conjugate with the optical pupil E but substantially conjugate with the optical pupil E in the Y direction parallel to the optical axis incidence plane. This permits improving the light use efficiency of the light source 11 and also permits providing an image with high color reproducibility.

As described above, the three light emitting parts 11R, 11G, and 11B of the light source 11 are arrayed in the X direction, the direction in which the diffusion by the one direction diffuser plate 12 is large, which means that the three light emitting parts 11R, 11G, and 11B are arranged in the direction vertical to the optical axis incidence plane. The direction vertical to the incidence plane is a direction in which the wavelength selectivity in the hologram optical element 24 is small; thus, arranging the three light emitting parts 11R, 11G, and 11B in the X direction permits mixture of the colors in the direction in which the optical pupil E can be enlarged, thus providing an image with little color unevenness and high image quality to the observer even when the light source 11 emitting three RGB colors is used.

In the direction parallel to the incidence plane, the wavelength selectivity of the hologram optical element 24 is high, and thus change in the color reproduction region due to position shift of the optical pupil E is large in the direction parallel to the incidence plane. However, in the present embodiment, performing optical axis adjustment does not change the position of the optical pupil E, thus resulting in no change in the color reproduction region due to the optical axis adjustment. That is, effect of causing no change in the color reproduction region due to optical axis adjustment is larger in the direction parallel to the incidence plane (direction in which the wavelength selectivity is high) than in the direction vertical to the incidence plane.

### (7. Pupil Position Adjustment By Light Source Position Adjustment)

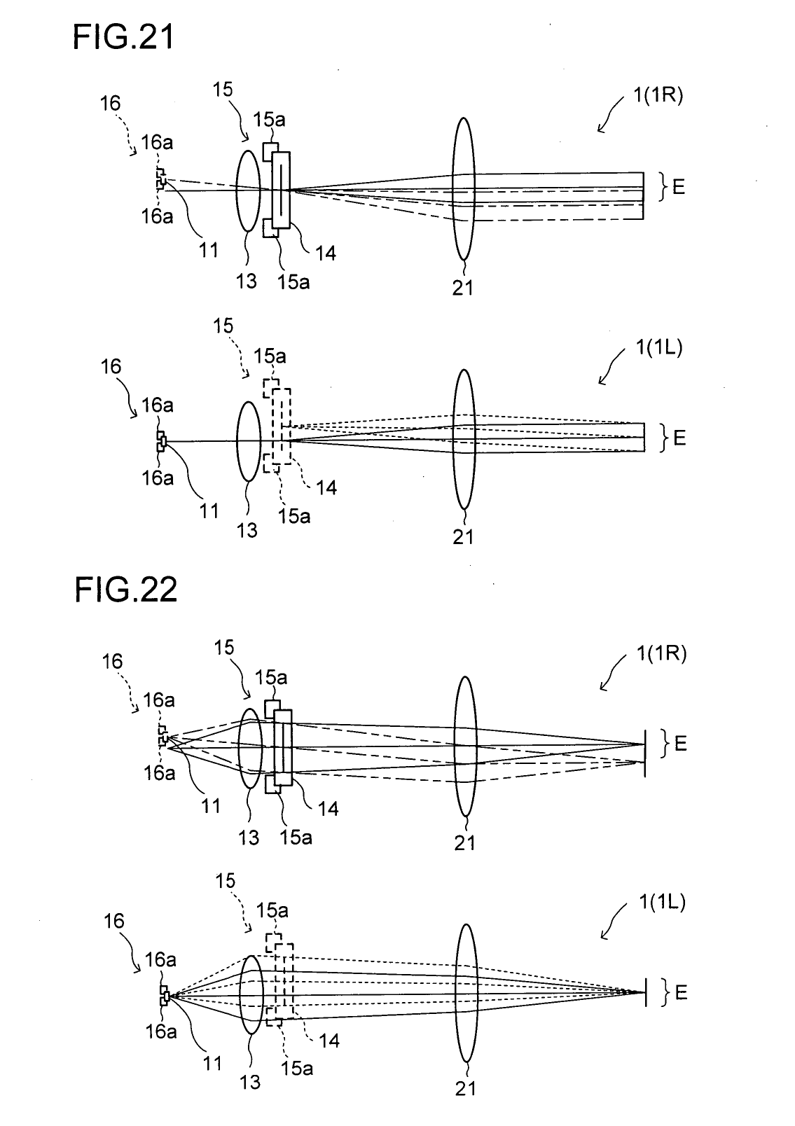

Next, the adjustment of the position of the optical pupil E by the adjustment of the position of the light source 11 will be described. FIG. 21 is an explanatory diagram showing another configuration example of the image display apparatus 1 of the present embodiment and showing expanded optical paths of light exiting from the centers of the display regions of the display devices 14 in the respective image display apparatuses 1R and 1L. FIG. 22 is an explanatory diagram showing expanded optical paths of light emitted from the light sources 11 of the image display apparatuses 1R and 1L with the configuration described above.

The image display apparatuses 1R and 1L further each have a light source position adjustment mechanism 16. This light source position adjustment mechanism 16 adjusts the position of the light source 11 (in the direction intersecting the optical axis) to thereby change the position of the optical pupil E, and has a holding part 1 6a which holds the light source 11. This holding part 16a is capable of sliding in the direction intersecting the optical axis while holding the light source 11. Therefore, the holding part 16a can be slid in the direction described above to adjust the position of the light source 11 and then fixed to the case 10 (see FIG. 9) at predetermined position to thereby adjust the position of the optical pupil E in the direction intersecting the optical axis without changing the angle formed by the pair of right and left optical axes, as shown in FIGS. 21 and 22.

As described above, the position of the optical pupil E can be changed by the light source position adjustment mechanism 16, regardless of the optical axis adjustment by the optical axis adjustment mechanism 15 (without changing the angle formed by the pair of right and left optical axes). Thus, for example, when the optical pupil E is formed at position other than the position where light of a desired wavelength reaches due to manufacturing error of the light source 11 and the hologram optical element 24 and apparatus mechanical error (design error), the optical pupil E can be located at the position where the light of a desired wavelength reaches without breaking positional relationship between the pair of right and left optical axes (while keeping the angle formed by the pair of optical axes constant). Therefore, even when the position of the optical pupil E is shifted due to manufacturing error or the like, an image of a desired color can be reliably observed by the observer through the movement of the pupil position by the position adjustment of the light source 11.

In particular, the position adjustment of the light source 11 and the optical axis adjustment have no influence on each other, thus permitting easy pupil position adjustment and also requiring not very high accuracy of the optical members and apparatus design accuracy. This in turn permits achieving an image display apparatus 1 at low costs.

As described above, since the wavelength selectivity of the hologram optical element 24 is high in the direction parallel to the optical axis incidence plane, the wavelength of image light guided to the optical pupil E can be easily changed by changing the position of the optical pupil E in the direction described above, thereby providing an image with high color reproducibility to the observer. In the direction vertical to the optical axis incidence plane, the hologram optical element 24 has some wavelength selectivity, although not large, thus resulting in small change in the wavelength caused by change in the position of the optical pupil E.

The hologram optical element 24 diffracts light of a particular wavelength entering at a particular angle of incidence. Thus, the adjustment of the position of the light source 11 can optimally adjust the angle of incidence and wavelength of the light entering the hologram optical element 24, thereby providing a bright image.

Here, it is configured such that only the light source 11 is moved in the direction intersecting the optical axis by the light source position adjustment mechanism 16 to adjust the position of the optical pupil E. Alternatively, it may be configured such that the condensing lens 13 is moved in the direction intersecting the optical axis to adjust the position of the optical pupil E. However, in this case, the condensing lens 13 moves relative to a display range of the display device 14, which requires the condensing lens 13 to be set a litter large.

### Third Embodiment

Still another embodiment of the invention will be described below, with reference to the accompanying drawings. Members with the same configuration as those of the first or second embodiment are provided with the same numerals, and thus omitted from the description.

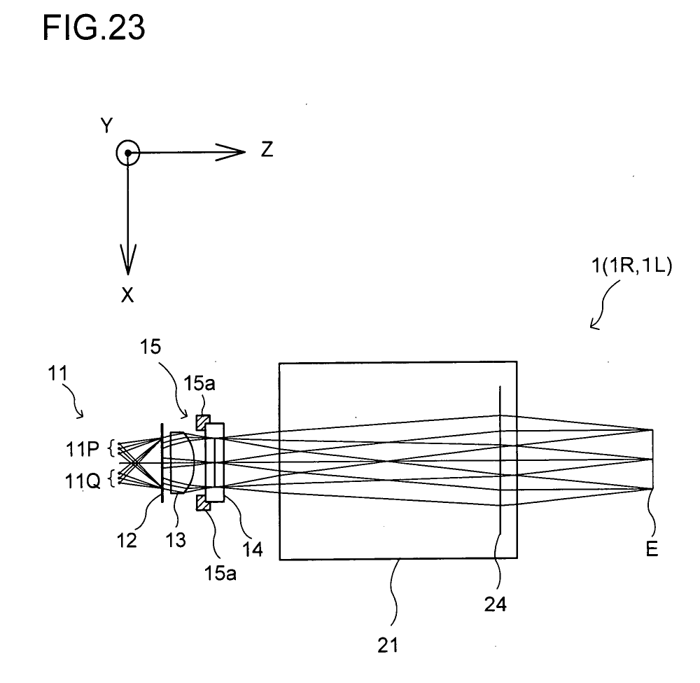

FIG. 23 is an explanatory diagram showing an optical path optically expanded in one direction in the image display apparatuse 1 (the image display apparatuses 1R and 1L) of the present embodiment. In the present embodiment, the image display apparatus 1 is configured in the same manner as that in the second embodiment except for that the light source 11 is composed of two light source groups 11P and 11Q. That is, also in the present embodiment, an optical axis adjustment mechanism 15 the same as that of the second embodiment is provided. Hereinafter, the description will be given, focusing on portions different from those in the second embodiment.

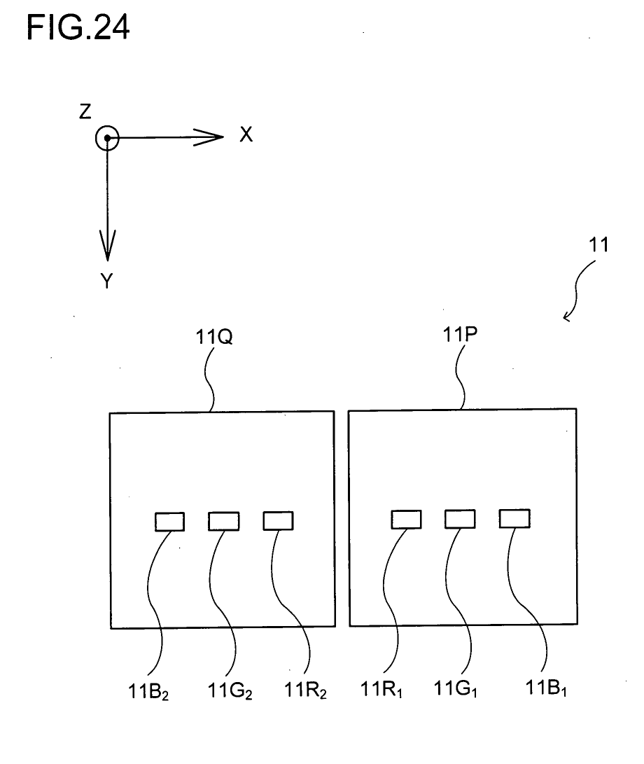

FIG. 24 shows a plan view of the light source 11 in the present embodiment as viewed from the display device 14 side. The light source group 11P of the light source 11 is formed of an RGB-unified LED having three light emitting parts 11R₁, 11G₁, and 11B₁ which emit light of RGB colors, respectively. Similarly, the light source group 11Q is formed of an RGB-unified LED having three light emitting parts 11R₂, 11G₂, and 11B₂ which emit light of RGB colors, respectively. That is, the light source 11 has two sets of three light emitting parts which emit light of RGB, respectively.

The light emitting parts of each of the light source groups 11P and 11Q are arranged alongside the direction vertical to the incidence plane along which the optical axis enters runs onto the hologram optical element 24 (YZ plane), and further arranged in such a manner as to be plane-symmetrical with respect to the incidence plane described above on an individual color basis. More in detail, the light emitting parts 11R₁ and 11R₂ are arranged at position closer to the incidence plane in such a manner as to be plane-symmetrical with respect to the incidence plane. On the outer side thereof in the X direction, the light emitting parts 11G₁ and 11G₂ are arranged in such a manner as to be plane-symmetrical with respect to the incidence plane. On the further outer side thereof in the X direction, the light emitting parts 11B₁ and 11B₂ are arranged in such a manner as to be plane-symmetrical with respect to the incidence plane. That is, each of the light source groups 11P and 11Q has the light emitting parts arranged in such an order that the wavelength of emitted light becomes shorter outwardly in the X direction from the incidence plane side.

In this manner, arranging the light emitting parts so that they are plane-symmetric with respect to the incidence plane on an individual color basis permits, for each of the RGB colors, locating within the symmetry surface (within the incidence plane) the center of gravity of a total light intensity obtained by summing up light intensities of light emitted from the two light emitting parts for the same color (for example, 11R₁ and 11R₂). That is, the intensity distribution for each of the RGB colors can be made symmetrical in the X direction with respect to the symmetry surface as a center. This permits providing to the observer an image with little color unevenness at the center of the optical pupil E.

The plane serving as the center of the plane symmetry of each of the light emitting parts may be parallel to the incidence plane. That is, the plane serving as the center of the plane symmetry of each of the light emitting parts may be a little shifted in the X direction from the incidence plane. In this case, an image with little color unevenness near the center of the optical pupil E can be provided to the observer.

When the light source 11 is composed of two light source groups and light emitting parts are so arranged as to be plane-symmetrical on an individual color basis, the order in which the light emitting parts are arrayed in the direction vertical to the incidence plane is opposite between the adjacent sets. On the other hand, even when the number of light source groups forming the light source 11 is 4 or larger, that is, even when the light source 11 is composed of an even number, equal to four or larger, of sets of RGB light emitting parts, providing opposite orders, in which the light emitting parts are arrayed in the direction vertical to the incidence plane, between the adjacent sets can locate for each of the RGB colors, within the same plane (including the incidence plane) parallel to the incidence plane, the center of gravity of a total light intensity obtained by summing up light intensities of light emitted from the light emitting parts. This in turn permits providing to the observer an image with little color unevenness at or near the center of the optical pupil E.

Therefore, summarizing the description above, if the light source 11 has an even number, equal to two or larger, of sets of three RGB light emitting parts and the order in which the light emitting parts are arrayed in the direction vertical to the incidence plane described above is opposite between the adjacent sets, an image with little color unevenness at or near the center of the optical pupil E can be provided to the observer.

Even when the number of light source groups forming the light source 11 is an even number equal to four or larger, if the light emitting parts are so arranged as to be plane-symmetric with respect to the incidence plane described above and also if the light emitting parts emitting light of the same color are located at the same distance from the incidence plane on the both sides in the direction vertical to the incidence plane, centers of gravity of light intensities agree with each other for each of the colors of light emitted from the respective light emitting parts. Therefore, when the number of light source groups forming the light source 11 is an even number, arranging the light emitting parts as described above permits providing to the observer an image with little color unevenness at the center of the optical pupil.

The hologram optical element 24 is, as described above, so fabricated as to diffract (reflect) image light of the wavelength widths, 465+5 nm, 521±5 nm, and 634±5 nm, with the peak-diffraction-efficiency wavelengths and the half-diffraction-efficiency wavelength widths. As described above, the half-diffraction-efficiency wavelength widths Δλ2 for the different colors agree with each other; thus, light of a longer wavelength has greater angle selectivity (experiences smaller shift in the angle of incidence with respect to wavelength change). Therefore, in each of the light source groups 11P and 11Q, arranging the light emitting parts in such an order that the wavelength of emitted light becomes shorter outwardly in the X direction from the optical axis incidence plane side permits, for each of the different colors, reducing intensity difference at the optical pupil E, which in turn permits providing to the observer an image with little color unevenness in the optical pupil E. Hereinafter, this point will be described in detail.

Where the peak-diffraction-efficiency wavelength is λ, the refractive index of a medium (interference fringe) of the hologram optical element 24 is n, the thickness of the medium is h, and the angle of incidence is θ, there exists relationship: λ=2nh cos θ. Here, in a case where, for B light of a short wavelength and R light of a long wavelength, their wavelengths are shifted by, for example, the same amount of 5 nm, the rate of wavelength change is 465/470 for the B light and 634/639 for the R light. That is, the rate of wavelength change is smaller for the R light of a long wavelength than for the B of a short wavelength. Therefore, shift in the angle of incidence θ with respect to wavelength change is smaller (angle selectivity is larger) for the R light of a long wavelength than for the B light of a short wavelength. Thus, when the wavelength widths of RGB of the light emitted from the light source 11 are equal, the size of the optical pupil formed by diffraction by the hologram optical element 24 is smaller for light of a longer wavelength. The optical pupil E includes all the ranges of the optical pupil of the respective colors.

On the other hand, intensities of light emitted from the LED (light emitting parts) of the light source 11 are usually stronger toward the center and weaker toward the surrounding area. The light emitting parts are so arranged as to be substantially conjugate with the optical pupil in the Y direction, but is not conjugate with the optical pupil in the X direction since it is diffused by the one direction diffuser plate 12. However, the position of the optical pupil where the intensity is strongest is almost the same as the position conjugate with the light emitting parts under the absence of the one direction diffuser plate 12.

Therefore, locating the pupil center for a long wavelength (R light) with a small optical pupil on the center side of the optical pupil E, and locating the pupil center for a short wave length (B light) with a large optical pupil on the outer side of the center of the optical pupil E permits reducing, for each of the different colors, intensity difference depending on the pupil position in the optical pupil E. This point will be also described in detail below.

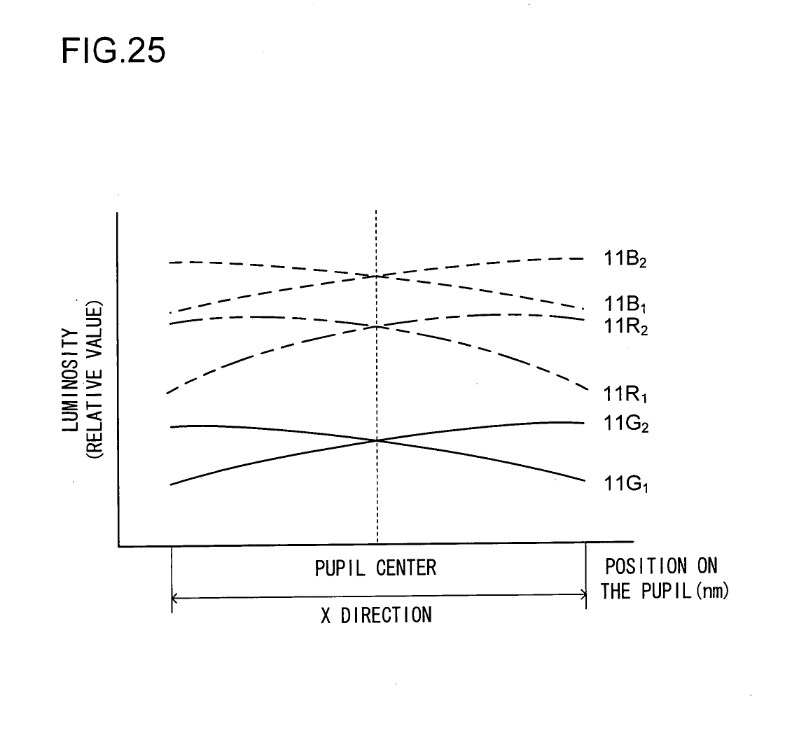

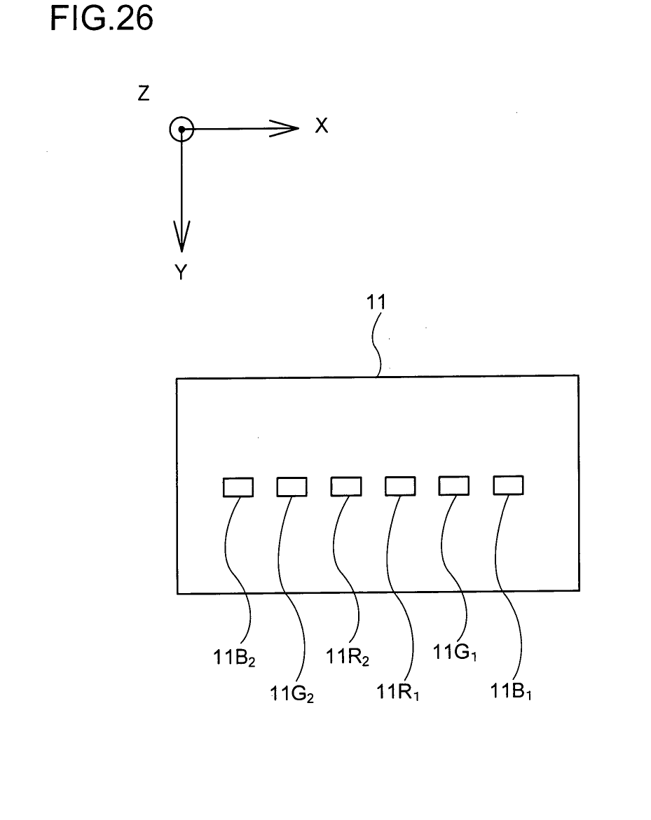

FIG. 25 is an explanatory diagram showing relationship between the pupil position in the X direction in the optical pupil E and light intensities. The light intensities are indicated by relative values for the same colors. Curved lines indicated by 11R₁, 11R₂, 11G₁, 11G₂, 11B₁, and 11B₂ in FIG. 25 correspond to light emitted from the light emitting parts 11R₁, 11R₂, 11G₁, 11G₂, 11B₁, and 11B₂, respectively.

As described above, due to the angle selectivity of the hologram optical element 24, the optical pupil is smaller for light of a longer wavelength. Therefore, as shown in FIG. 25, light of a longer wavelength has larger intensity difference depending on the pupil position (larger intensity difference between the center and end part of the optical pupil E). Contrarily, the optical pupil is larger for light of a shorter wavelength. Therefore, light of a shorter wavelength has smaller intensity difference depending on the pupil position.

The light emitting part emitting light of a longer wavelength is arranged closer to the optical axis incidence plane; therefore, the position where the light intensity is high is closer to the center of the optical pupil E for light of a longer wavelength. Contrarily, the light emitting part emitting light of a shorter wavelength is arranged at position more distant from the optical axis incidence plane; therefore, the position where the light intensity is high is located at the surrounding of the optical pupil E.

That is, light of a longer wavelength has larger intensity difference depending on the pupil position. However, arranging the light emitting parts in such an order that the wavelength of emitted light becomes shorter outwardly in the X direction from the optical axis incidence plane side and locating the position where the light intensity is high closer to the center of the optical pupil E for light of a longer wavelength permits reducing, for light of a longer wavelength, intensity difference depending on the pupil position, that is, intensity difference between the center and end part of the optical pupil E. As a result, an image with little color unevenness at the entire optical pupil E (at the center of the pupil and around the pupil) can be provided to the observer.

The light emitting parts of each of the light source groups 11P and 11Q are arranged in the X direction in an increasing order of the degree of diffusion that light of corresponding wavelengths undergoes (that is, the shorter the wavelength of light, the higher degree of diffusion it undergoes). Thus, intensity difference on the optical pupil E is even smaller for each of the different colors, thus permitting further reduction in the color unevenness. That is, an image with high color purity can be provided to the observer.

The description above refers to an example where two sets of RGB light emitting parts are provided and the light source 11 is composed of the light source groups 11P and 11Q respectively having these sets provided in individual packages, although these sets may be provided in one package. FIG. 26 shows another configuration example of the light source 11 in a plan view as viewed from the display device 14 side.

As described above, the light source 11 may be composed of the light emitting parts 11R₁, 11R₂, 11G₁, 11G₂, 11B₁, and 11B₂ emitting RGB light which are provided in one package. Also with this configuration, application of the arrangement method of the light emitting parts described above can reduce, for each of the different colors, intensity difference on the optical pupil E, thus reducing color unevenness. With closer distance between emission points, the RGB colors are more likely to be mixed together, so that a brighter image can be provided. In this regard, the configuration of FIG. 26, in which the distance between the light emitting parts can be easily reduced, is preferable.

### Fourth Embodiment

Sill another embodiment of the invention will be described below with reference to the accompanying drawings. Members with the same configuration as those in the first to third embodiments are provided with the same numerals and thus omitted from the description.

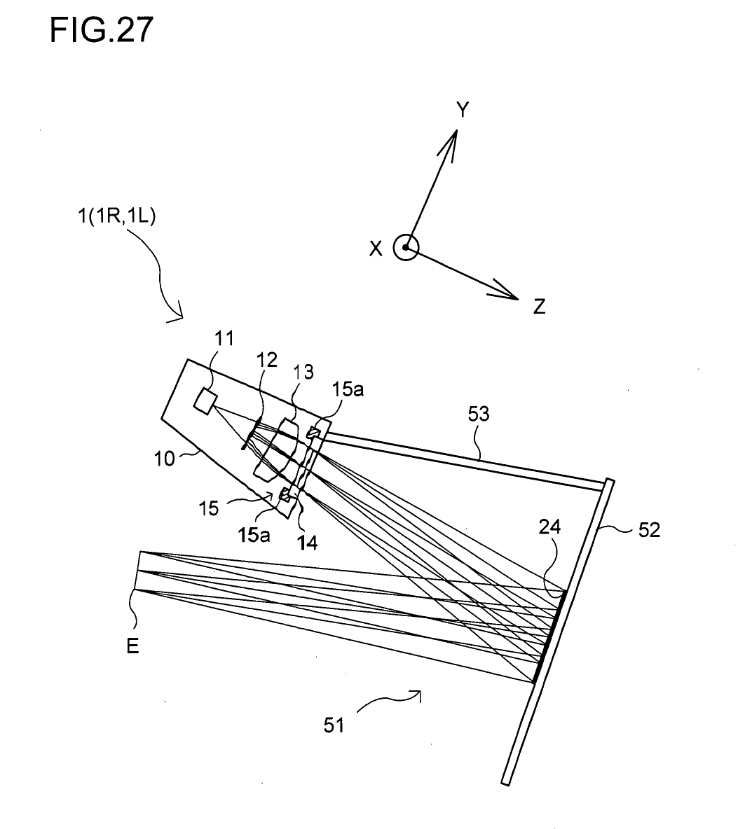

FIG. 27 is a sectional view showing schematic configuration of the image display apparatus 1 (the image display apparatuses 1R and 1L) according to the present embodiment. The image display apparatus 1 of the present embodiment is identical to those in second embodiment except for that they have light sources 11 each formed of a white light source (white LED) which excites a phosphor with blue color light or ultraviolet light to emit white light and also that they have ocular optical systems 51 replacing the ocular optical systems 21. That is, also in the present embodiment, the same optical axis adjustment mechanisms 15 as those in the second embodiment are provided. Hereinafter, the description will be given, focusing on portions different from those in the second embodiment.

The ocular optical system 51 (observation optical system) has a hologram optical element 24 formed on a transparent substrate 52. The substrate 52 is coupled to a case 10 via a support 53. The hologram optical element 24, as in the embodiments described above, has an axis-asymmetric positive power, and is so fabricated as to diffract image light of wavelength bands, 465±5 nm, 521±5 nm, and 634±5 nm, with peak-diffraction-efficiency wavelength wavelength widths. A method of fabricating the hologram optical element 24 in the present embodiment will be described in detail later.

In the configuration described above, light emitted from the light source 11 is diffused by a one direction diffuser plate 12, condensed in the Y direction by a condensing lens 13 to illuminate a display device 14, and then modulated by the display device 14. Image light from the display device 14 is diffracted by the hologram optical element 24 and then guided to an optical pupil E. In this condition, the hologram optical element 24 is formed to be larger in the direction vertical to the optical axis incidence plane than in the direction parallel to the optical axis incidence plane, and so set as to provide relationship such that the light source 11 and the optical pupil E is substantially conjugate with each other. Thus, the sizes of the light emitting parts of the light source 11 (for example, x=3 mm and y=0.5 mm) are enlarged to sizes three times larger than the image magnification of an optical system and further a little enlarged by diffusion at approximately I degree by the display device 14, so that the sizes of the optical pupil E are x=10 mm and y=2.5 mm.

As described above, in the present embodiment, the white light source is used as the light source 11, which does not require the RGB colors to be mixed together. Thus, the light source 11 and the optical pupil E can be so arranged as to be substantially conjugate with each other, thus providing a bright image.

Moreover, the optical pupil E is larger in one direction (X direction) than the human pupil (approximately 3 mm), thus permitting the observer to easily observe an image. Further, in a different direction (Y direction), condensation is achieved on the optical pupil E sized substantially equal to that of the human pupil, thus permitting providing a bright image to the observer without loss.

Morover, in the present embodiment in which the ocular optical system 51 is formed by attaching the hologram optical element 24 on the substrate 52, image light from the display device 14 directly enters the hologram optical element 24, thus permitting a smaller angle of incidence of light onto interference fringe recorded on the hologram optical element 24 than that in the second embodiment.

More in detail, with the configuration of the second embodiment, the angle of incidence of light entering the hologram optical element 24 is, for example, approximately 25 to 35 degrees in the medium. With the configuration of the present embodiment, this angle of incidence can be, for example, approximately 10 to 15 degrees in the medium. Consequently, compared to the second embodiment, influence of change in the angle of incidence on the wavelength selectivity is smaller, thus resulting in smaller color shift. Therefore, an image with high color purity and a wide color reproduction region can be displayed on an optical pupil E larger than that in the second embodiment.

The color reproduction region in the image display apparatus 1 of the present embodiment is a region indicated by the dashed line A2 shown in FIG. 19. It can be understood that this color reproduction region is wider than those respectively indicated by the broken line A3 and the chain dashed line A4. Therefore, also in the image display apparatus 1 of the present embodiment, the color purity can be increased to widen the color reproduction region.

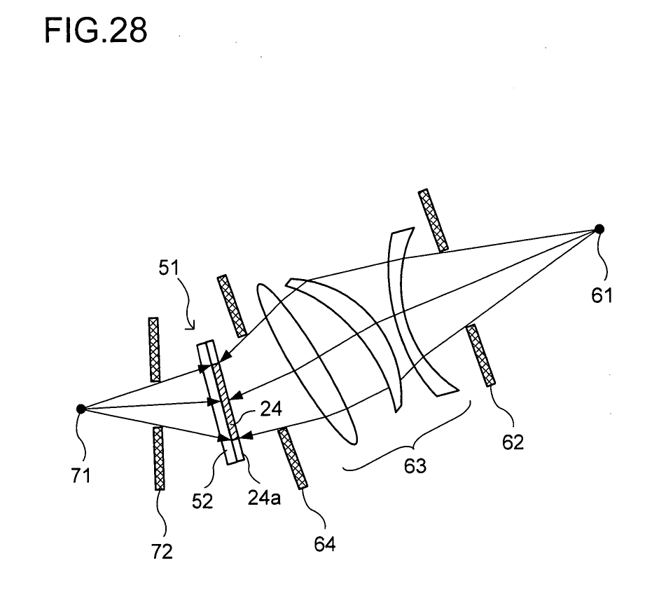

Next, a method of fabricating the hologram optical element 24 of the present embodiment will be described. FIG. 28 is a sectional view showing schematic configuration of the optical system used for fabricating the hologram optical element 24 of the present embodiment.

First, a hologram photosensitive material 24a is applied onto the substrate 52. Here, the hologram photosensitive material 24a is applied onto the substrate 52 over a range wider than the irradiation range of two beams used upon fabrication. Then, the substrate 52 with the hologram photosensitive material 24a applied thereon is arranged at predetermined position of the optical system shown in FIG. 28.

In the optical system described above, laser light from a light source, not shown, is diverged into two beams and converted into point light sources 61 and 71, respectively. Light emitted from the point light source 61 (one of the two beams used upon fabrication) is irradiated to the hologram photosensitive material 24a on the substrate 52 from the front surface side thereof (side opposite to the substrate 52) via an aperture stop 62, a manufacturing optical system 63, and an aperture stop 64 in order just mentioned. The irradiation of the emitted light described above to the hologram photosensitive material 24a via the manufacturing optical system 63 permits providing the formed hologram optical element 24 with an axis-asymmetric positive power. The range over which the emitted light described above is irradiated to the hologram photosensitive material 24a is a range which permits diffracting, of reproduction light, only the center beam.

On the other hand, light emitted from the point light source 71 has a beam diameter thereof restricted by an aperture stop 72, and irradiated to the hologram photosensitive material 24a on the substrate 52 from the rear side thereof (the substrate 52 side). The range over which the emitted light described above is irradiated to the hologram photosensitive material 24a is a range which permits diffracting, of reproduced light, only the center beam.

As a result of the irradiation of these two beams, interference fringe is recorded on a portion where the irradiation ranges of the two beams in the hologram photosensitive material 24a are superimposed on each other, fabricating the hologram optical element 24. Thereafter, baking processing and fixation processing are performed, thereby completing the ocular optical system 51.

In the optical system described above, numeric apertures (beam diameters of the emitted light) of the point light sources 61 and 71 are restricted by the aperture stops 62, 64, and 72 Thus, the two beams used upon the fabrication can be sized equally on the hologram photosensitive material 24a, and the hologram optical element 24 can be fabricated only in the range where, of the reproduction light, the central beam having favorable optical performance is irradiated. Moreover, the two beams used upon the fabrication interfere in the same range. Thus, interference by only one laser light is less likely to occur, so that unnecessary interference fringe is not recorded on the hologram photosensitive material 24a. Therefore, the hologram optical element 24 having favorable optical performance and less likely to cause flare and ghost can be fabricated, thus providing an image with high image quality to the observer.

Further, the two beams used upon the fabrication are formed by restricting divergence angles of the light emitted from the corresponding point light sources 61 and 71 by the aperture stops 62, 64, and 72, thus permitting easy, reliable, and low-cost control of the size of the hologram optical element 24 on the substrate 52.

The beam diameter of light emitted from the point light source 61 is restricted by the two aperture stops 62 and 64, and this restriction first done by the aperture stop 62 permits suppressing emergence of unnecessary light reflected or diffused at the end part of the manufacturing optical system 63 or the like. Then, the restriction of the beam diameter of the emitted light by the aperture stop 64 permits preventing unnecessary light which is reflected between the planes in the manufacturing optical system 63, from reaching the hologram photosensitive material 24a.

The point light source 71 is arranged near the optical pupil E. Bringing the position of the point light source 71 upon the fabrication of the hologram optical element 24 substantially in agreement with the position of the optical pupil E in this manner permits providing the same image display colors without depending on the position of the screen. Moreover, the wavelength of light diffracted by the hologram optical element 24 and then reaching the optical pupil E upon the reproduction varies depending on the position of the optical pupil E. However, in the present embodiment, the optical axis adjustment mechanism 15 performs optical axis adjustment without changing the position of the optical pupil E relative to the ocular optical system 21, thus permitting maintaining favorable color reproducibility without changing the wavelength of the light reaching the optical pupil E through the optical axis adjustment.

### Fifth Embodiment

Still another embodiment of the invention will be described below, with reference to the accompanying drawings. Members with the same configuration as those in the first to fourth embodiments are provided with the same numerals. The configuration not mentioned in the first to fourth embodiment will be described as appropriate.

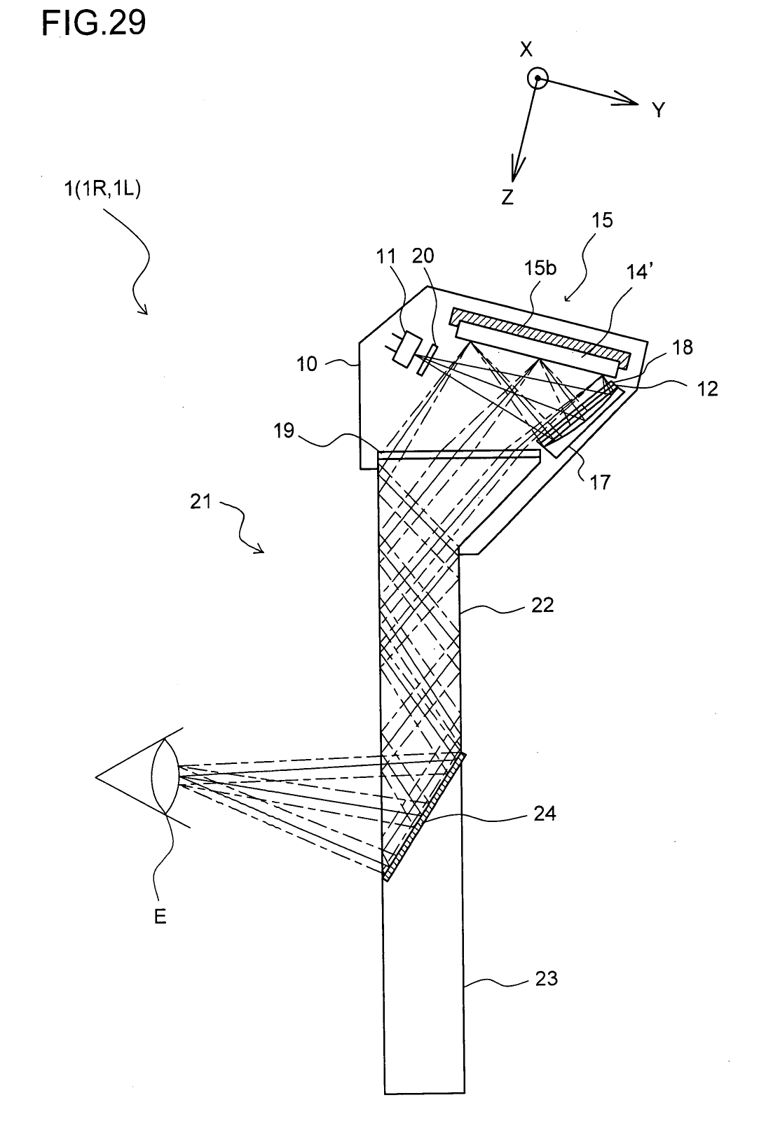

FIG. 29 is a sectional view showing schematic configuration of the image display apparatus 1 (the image display apparatuses 1R and 1L) according to the present embodiment. The image display apparatuses 1R and 1L 1 of the present embodiment each has a light source 11, an one direction diffuser plate 12, a display device 14′, an optical axis adjustment mechanism 15, a optical path bending member 17, a first polarizing plate 18 (polarizer), a second polarizing plate 19 (analyzer), a third polarizing plate 20, and an ocular optical system 21. The optical members other than the ocular optical system 21 are stored in a case 10, which is supported by part of the ocular optical system 21 (an ocular prism 22 in the same figure). Hereinafter, the description will be given, focusing on portions different from those in the embodiments described above.

The light source 11 is formed of an RGB-unified LED, and wavelength of the RGB almost agree with wavelengths of light deflected and reflected by the hologram optical element 24. In the present embodiment, as described later, a ferroelectric liquid crystal display device capable of being driven in a time-division mode (field sequencial) is used as the display device 14′; thus, the light source 11 emits light corresponding to the three primary colors in order in a time-division mode. Moreover, the optical path bending member 17 to be described later has no optical power in the X direction; thus, the light source 11 and the optical pupil E are substantially conjugate with each other in the Y direction.

The display device 14′ is a light modulation device which has a plurality of pixels in a matrix form and which modulates light emitted from the light source 11 in accordance with image data for each of the pixels to thereby display an image. More in detail, the display device 14′ is formed of a reflective ferroelectric liquid crystal display device that is formed by sandwiching a ferroelectric liquid crystal with two substrates, with a reflective film (reflecting electrode, pixel electrode) being formed on one of the substrate. The reflective ferroelectric liquid crystal display device has no color filters, and thus the pixels of the display device 14′ are driven ON/OFF in a time-division mode in correspondence with light of the three primary colors supplied in a time-division mode from the light source 11. This permits providing a color image to the observer.

The reflective ferroelectric liquid crystal display device is excellent in a point that it has a wider view angle characteristic than a TN (Twisted Nematic) liquid crystal display device, and thus can provide an image with high contrast, high color reproducibility (a wide color reproduction region), and high display grade, even when an angle of incidence of light entering from the optical path bending member 17 to be described later to the display device 14′ is large. Moreover, the degree of freedom in arranging the optical devices is higher, thus permitting achieving a compact, high-performance image display apparatus 1.

The display device 14′ may be formed of a combination of a phase compensating plate and a TN liquid crystal display device with an improved view angle characteristic. Moreover, the display device 14′ may be a reflective display device capable of being driven in a time-division mode, and thus can also be formed of, for example, a DMD (Digital Micromirror Device manufactured by US Texas Instrument Corporation).

The optical axis adjustment mechanism 15 has the same function as those in the other embodiments, but in the present embodiment, has a holding frame 15b (holding part) which holds the substrate of the display device 14′ from the rear side. This holding frame 15b is capable of sliding in the direction intersecting the optical axis (here, direction substantially parallel to a display plane of the display device 14′), and finally fixed to the case 10. The holding frame 15b can be slid in this manner to adjust the position of the display device 14′, thereby changing in the direction intersecting the optical axis relative positional relationship between an image displayed on the display device 14′ and the ocular optical system 21.

The optical path bending member 17 is a reflective mirror which reflects light emitted from the light source 11 and then guides the light to the display device 14′, and has a function of bending an optical path from the light source 11 to the display device 14′. In the present embodiment, the optical path bending member 17 is formed of a cylindrical concave mirror which condenses light from the light source 11 only in the Y direction, and is provided on the side opposite to the light source 11 with respect to an optical path of light traveling from the display device 14′ to the ocular optical system 21. That is, the optical path bending member 17 is provided at position such that the optical path described above is sandwiched between the light source 11 and the optical path bending member 17.

The first polarizing plate 18 transmits, of light emitted from the light source 11, the light in a predetermined polarization direction (here, P polarized light) and then guides this light to the optical path bending member 17, and also transmits light whose optical path is bent by the optical path bending member 17 and whose polarization direction is the same as the predetermined polarization direction described above (here, P polarized light) and then guides this light to the display device 14′.

The second polarizing plate 19 transmits, of incident light, the light (here, S polarized light) in the polarization direction orthogonal to the polarization direction of the light transmitted through the first polarizing plate 18 and then guides this light to the ocular prism 22, and is attached to the surface of the ocular prism 22 where light form the display device 14′ enters.

The arrangement of such a second polarizing plate 19 permits even unnecessary light (P polarized light) traveling in the direction from the light source 11 to the ocular prism 22 to be reliably cut by the second polarizing plate 19, thus reliably preventing emergence of ghost and flare attributable to this unnecessary light.

The third polarizing plate 20 transmits, of light emitted from the light source 11, the light (P polarized light) in the same polarization direction as the polarization direction of the light transmitted through the first polarizing plate 18 and then guides this light to the optical path bending member 17. This third polarizing plate 20 is arranged on the light source 11 side with respect to an optical path of light traveling from the display device 14′ toward the ocular optical system 21 (between the aforementioned optical path and the light source 11).

The arrangement of such a third polarizing plate 20 permits previously cutting, of the light emitted from the light source 11, the light (S polarized light) in the polarization direction that can be transmitted through the second polarizing plate 19, by the third polarizing plate 20. That is, the arrangement of the third polarizing plate 20 prevents the S polarized light from directly reaching the ocular optical system 21 from the light source 11 or from reaching the ocular optical system 21 after reflected on the front surface of the first polarizing plate 18. This permits preventing emergence of ghost (flare) caused by such light, thus reliably avoiding image quality degradation.

In the configuration described above, once light of the respective RGB colors from the light source 11 are emitted in a time-division mode, the light of the respective colors (for example, P polarized light) is first transmitted through the third polarizing plate 20, next transmitted through the first polarizing plate 18 and the one direction diffuser plate 12, and then reflected by the optical path bending member 17. Then, the light (P polarized light) reflected by the optical path bending member 17 is again transmitted through the one direction diffuser plate 12 and the first polarizing plate 18, and then enters the display device 14′.

In the display device 14′, the incident light is reflected, upon which it is modulated in accordance with image data for the respective RGB and then exits from the display device 14′ while turning into polarized light (S polarized light) different from the incident light. At this point of time, images in accordance with the image data individually for the respective RGB are displayed on the display device 14′ in a time-division mode. The light emitted from the display device 14′ (image light for the respective RGB) travels across an optical path from the light source 11 to the optical path bending member 17 and then reaches the ocular optical system 21, is transmitted through the second polarizing plate 19, and then enters the ocular prism 22.

In the ocular prism 22, the incident image light is totally reflected on two opposing planes of the ocular prism 22 a plurality of times, guided to the hologram optical element 24 arranged at a lower end of the ocular prism 22, reflected thereon, and then reaches the optical pupil E. Therefore, at this position of the optical pupil E, the observer can observe, as a color image, enlarged virtual images of the images for the respective RGB displayed on the display device 14′.

On the other hand, the ocular prism 22, the deflecting prism 23, and the hologram optical element 24 transmit almost all outside light, thus permitting the observer to observe outside image in a see-through manner. The virtual images of the images displayed on the display device 14′ are observed in a manner such that they are partially superimposed on the outside image.

As described above, also in the image display apparatuses of the present embodiment, the optical axis adjustment mechanisms 15 are provided, thus permitting avoiding luminance deterioration and image quality degradation of an observed image at the position of the optical pupil E caused by optical axis adjustment.

In the reflective display device 14′, a semiconductor of silicon or the like can be used as a substrate, thus permitting fabrication of a compact display device with high integration degree. Moreover, a surrounding circuit including a switching device (for example, TFT) for turning on and off of the pixels and wires can be arranged on the substrate on the side opposite to the display side, thus permitting easily improving the aperture ratio and displaying a bright image.

The ferroelectric liquid crystal display device is advantageous for its fast driving speed, so that forming the display device 14′ with a reflective ferroelectric liquid crystal display device permits adoption of the time-division driving method described above.

Here, a conventional color filter method by which a color image is displayed by RGB light transmitted through color filters is a space-division driving method in which a white light source is constantly turned on and any of the RGB color filters is arranged at one pixel to achieve color display, which requires three times more pixels than monochrome display. To block image light of an unnecessary color, the blockage needs to be performed at each of the pixels while the light source is kept on. Since complete blockage at each of the pixels is difficult, the color purity of a single color is low in the color filter method.

Contrarily, in the time-division driving method, the light emitting parts for the RGB at the light source are sequentially turned on. Thus, for example, to display a single color, the light emitting parts for the remaining two colors are turned off. This permits display of an image with high color purity and high contrast. Moreover, the display device 14′ adopting the time-division driving method has no color filters, and thus can display a bright image with high light transmittance.

In the reflective display device 14′, the aperture ratio is high as described above, and thus diffusion of light transmitted through the pixels is small. Therefore, the light source 11 and the optical pupil E can be reliably made conjugate with each other in the Y direction.

### Sixth Embodiment

Still another embodiment of the invention will be described below with reference to the accompanying drawings. Members with the same configuration as those in the first to fifth embodiments are provided with the same numerals and thus omitted from the description. In the present embodiment, a head-mounted display (hereinafter also referred to as HMD) applying the image display apparatuses of the embodiments described above will be described.

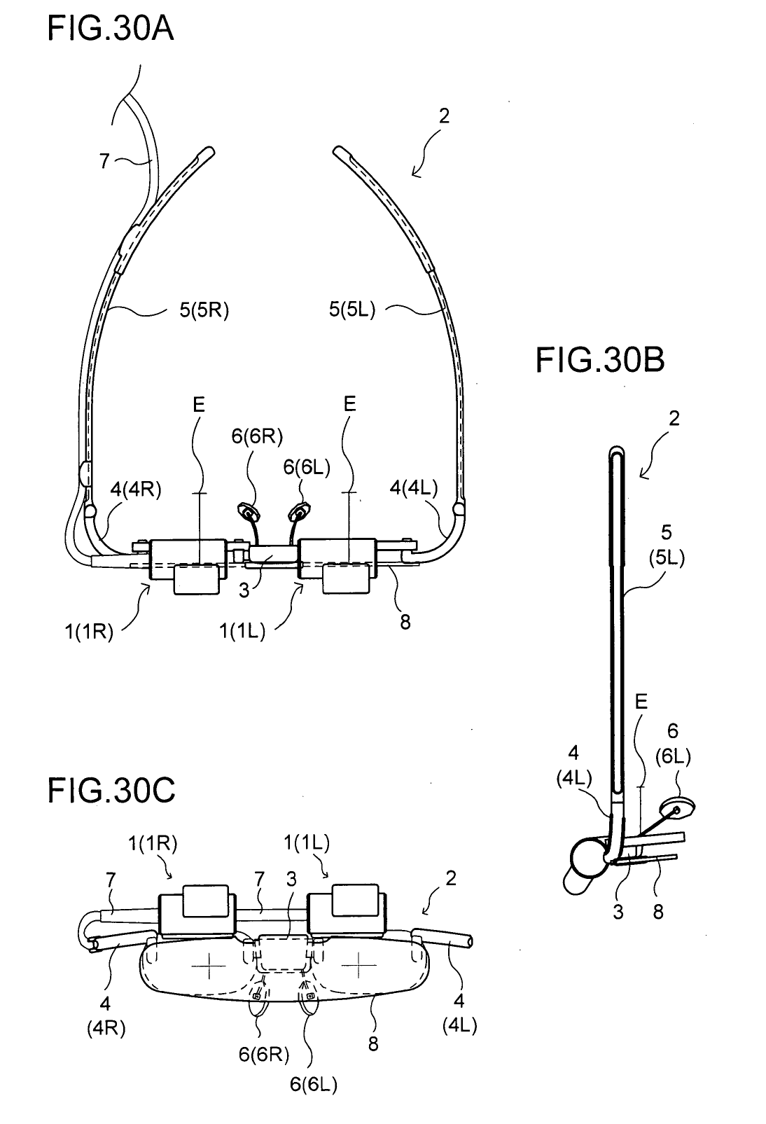

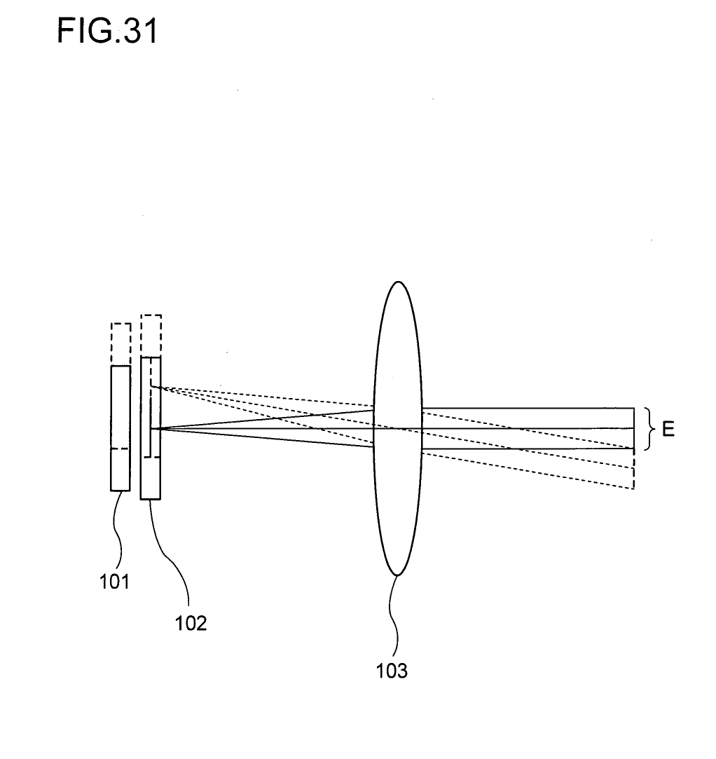

FIG. 30A is a plan view showing schematic configuration of the HMD according to the present embodiment. FIG. 30B is a side view of the HMD. FIG. 30C is an elevation view of the HMD. The HMD has: two image display apparatuses 1R and 1L which are arranged in front of the right and left eyes, respectively, of the observer; and support means 2 (support member) adapted to support them.

The image display apparatuses 1R and 1L enables the observer to observe an outside image in a see-through manner, and displays an image and then provides this image as a virtual image to the observer, and can adopt the configuration described in the above embodiments. In the image display apparatuses 1R and 1L shown in FIG. 30C, portions corresponding to a right eye lens and a left eye lens of glasses is formed by attaching together the ocular prism 22 and the deflecting prism 23.

The support means 2 supports the image display apparatuses 1R and 1L in front of the right and left eyes, respectively, of the observer, and has a bridge 3, frames 4, temples 5, nose pads 6, a cable 7, and external light transmittance control means 8. The nose pads 6 and the external light transmittance control means 8 are supported by the bridge 3. The frames 4, the temples 5, and the nose pads 6 are provided in pairs on the right and left. To discriminate them with reference to the right and left, they are expressed as: the right frame 4R, the left frame 4L, the right temple 5R, the left temple 5L, the right nose pad 6R, and the left nose pad 6L.

The image display apparatuses 1R and 1L are coupled to the bridge 3. The right temple 5R is rotatably supported by the right frame 4R, and coupled via this right frame 4R to the image display apparatus 1R on the side opposite to the side on which it is coupled to the bridge 3. Similarly, the left temple 5L is rotatably supported by the left frame 4L, and coupled via this left frame 4L to the image display apparatus 1L on the side opposite to the side on which it is coupled to the bridge 3.

The cable 7 is a wire for supplying an external signal (for example, an image signal or a control signal) and an electrical power to the image display apparatuses 1R and 1L, and is provided along the right temple 5R , the right frame 4R, and the bridge 3. The external light transmittance control means 8 is provided in order to control the transmittance of external light (light of an outside image), and located forward of the image display apparatuses 1R and 1L (on the side opposite to the observer).

To use the HMD, the observer brings the right temple 5R and the left temple 5L into contact with his or her right and left temporal regions, respectively, and also brings the nose pads 6 into contact with him or her to thereby fit the HMD to his or her head in the same manner as when glasses are fitted. When images are displayed by the image display apparatuses 1R and 1L in this state, the observer can observe, as virtual images, the images respectively displayed by the image display apparatuses 1R and 1L with his or her both eyes, and can also observe an outside image in a see-through manner via these image display apparatuses 1R and 1L.

In this condition, setting the external light transmittance as low as, for example, 50% or less in the external light transmittance control means 8 permits the observer to easily observe images of the image display apparatuses 1R and 1L. Contrarily, setting the external light transmittance as high as, for example, 50% or more permits the observer to easily observe an outside image. Therefore, the external light transmittance in the external light transmittance control means 8 can be set appropriately, considering images of the image display apparatuses 1R and 1L and an outside image.

As described above, the HMD of the present embodiment has the image display apparatuses 1R and 1L and the support means 2 adapted to support the image display apparatuses 1R and 1L in front of the respective eyes of the observer. Since the image display apparatuses 1R and 1L are supported by the support means 2, the observer can observe images provided from the image display apparatuses 1R and 1L in a handsfree manner.

The present embodiment has been described above, referring to an example where the image display apparatuses 1R and 1L are applied to the HMD, but it may also be applied to, for example, an HUD (head up display).

It is of course possible to appropriately combine the configuration and methods described in the different embodiments to form an image display apparatus or an HMD.

The invention can also be expressed as follow, and the following effects can be provided by the invention.

An image display apparatus of the invention includes: a pair of right and left light sources; a pair of right and left display devices which modulate light from the respective light sources to display images; a pair of right and left observation optical systems which guide light of the images displayed on the respective display devices to a pair of right and left optical pupils, respectively; and optical axis adjustment means which, for at least one of the right and left, changes relative positional relationship between the image displayed on the display device and the observation optical system in a direction intersecting an optical axis to thereby adjust an angle formed by a pair of right and left optical axes. On each of the right and left, the light source is so arranged as to be substantially conjugate with the optical pupil, and the optical axis adjustment means changes the positional relationship described above without changing a position of the optical pupil relative to the observation optical system.

With the configuration described above, on each of the right and left, the light source is so arranged as to be substantially conjugate with the optical pupil, and the optical axis adjustment means can perform optical axis adjustment without changing the position of the optical pupil relative to the observation optical system. Consequently, light intensity at a designed optical pupil position can be achieved even after the optical axis adjustment, thus avoiding luminance deterioration of an observed image at the optical pupil position caused by the optical axis adjustment. Moreover, a portion of the observation optical system designed so as to suppress occurrence of aberration can be utilized to guide the image light from the display device to the optical pupil, thereby suppressing occurrence of aberration attributable to the optical axis adjustment and thus avoiding image quality degradation of the observed image caused by aberration.

In the invention, the optical axis adjustment means may be configured to change the positional relationship described above by adjusting the position of the display device relative to the observation optical system (change it in the direction intersecting the optical axis).

Even in the adjustment of the position of the display device relative to the observation optical system, the optical axis adjustment can be performed without changing the position of the optical pupil relative to the observation optical system. Therefore, luminance deterioration and image quality degradation of the observed image caused by the optical axis adjustment can be avoided.

The image display apparatus of the invention may be configured to further include a pair of right and left illumination optical systems which condense light from the respective light sources and then guide the light to the respective display device.

In this case, the light from the light source is condensed by the illumination optical system and then guided to the display device, thereby permitting an improvement in the light use efficiency and thus providing a bright image to the observer. In addition, this permits a shorter distance between the light source and the display device, thus providing a compact and light-weight apparatus.

In the invention, it is preferable that the light source be an LED. The LED is low-price and compact, and has a narrow light emission wavelength width and thus high color purity. Therefore, the formation of the light source with the LED permits achieving a low-price, compact image display apparatus which provides an image with high color purity.

In the invention, the light source may emit light having a plurality of wavelengths at which the light intensity is peak. In this case, the light source emits light of at least two colors. Thus, light from the light source can be modulated by the display device and then guided to the pupil of the observer via the observation optical system, thereby permitting the observer to observe a color image.

In the invention, on each of the right and left, the observation optical system may include a volume phase type, reflective hologram optical element. The hologram optical element may be configured to diffract and reflect image light from the display device and then guide the image light to the optical pupil.

The volume phase type, reflective hologram optical element has high diffraction efficiency and also a narrow half-diffraction-efficiency wavelength width. Therefore, using such a hologram optical element to provide configuration such that image light from the display device is diffracted and reflected by the hologram optical element and then guided to the optical pupil permits providing a bright image with high color purity to the observer. In particular, in the invention, as described above, the position of the optical pupil in the optical axis adjustment is not changed, so that the wavelength of image light reaching the optical pupil does not change, which permits providing an image with high color reproducibility.

The image display apparatus of the invention may be configured to further include a pair of right and left light source position adjustment mechanisms which respectively change the positions of the optical pupils by adjusting the positions of the light sources. In this case, for example, even when, due to manufacturing error, the optical pupil is formed at a position different from a position where light of a desired wavelength reaches, the optical pupil can be located by the light source position adjustment mechanism at the position where the light of a desired wavelength reaches, thus permitting the observer to observe an image of a desired color.

In the configuration in which a volume phase type, reflective hologram optical element having a narrow half-diffraction-efficiency wavelength width, the light source is movable, thus permitting easily changing an image color to a desired color by changing the wavelength of image light. The hologram optical element diffracts light of a particular wavelength entering at a particular angle of incidence. Therefore, adjusting the position of the light source permits optimally adjusting the angle of incidence and wavelength of light entering the hologram optical element, thereby providing a bright image. Further, independently from the optical axis adjustment by the optical axis adjustment means (without changing the angle formed by the pair of right and left optical axes), the position of the optical pupil can be changed by moving the light source by the light source position adjustment mechanism, thus permitting easy position adjustment of the optical pupil.

In the invention, it is preferable that the hologram optical element have an axis-asymmetric positive optical power. Use of such a hologram optical element permits improving the degree of freedom in arranging optical members forming the apparatus, thus making it easy to downsize the apparatus.

In the invention, it is preferable that the optical pupil be larger in the direction vertical to an incidence plane along which the optical axis runs onto the hologram optical element than in the direction parallel to the incidence plane. The incidence plane along which the optical axis runs onto the hologram optical element means a plane including an optical axis of incident light and an optical axis of reflected light on the hologram optical element.

When the hologram optical element is axis-asymmetrical, in the direction parallel to the incidence plane along which the optical axis runs onto the hologram optical element, the hologram optical element has a large wavelength characteristics (large wavelength selectivity), so that shift in the angle of incidence of incident light is likely to cause shift in the diffracted wavelength. Therefore, enlarging the optical pupil in the direction vertical to the incidence plane described above, that is, enlarging the optical pupil in the direction in which the wavelength characteristic is small permits providing to the observer an easy-to-observe image with little color unevenness. The size of the optical pupil is comparatively small in the direction parallel to the incidence plane than in the direction vertical to the incidence plane, thus permitting light from the light source to be condensed without loss to provide a bright image to the observer.

In the invention, it is preferable that the light source and the optical pupil be substantially conjugate with each other in the direction parallel to the incidence plane. In this case, the light use efficiency of the light source can be improved, and an image with high color reproducibility and high color purity can be provided.

In the invention, it is preferable that the light source have (at least one set of) three light emitting parts which emit light respectively corresponding to three primary colors, and that the light emitting parts be arranged alongside the direction vertical to the incidence plane.

As described above, the direction vertical to the incidence plane is a direction in which the wavelength characteristic in the hologram optical element is small. Therefore, the arrangement of the three light emitting parts emitting light of the respective colors alongside the direction in which the wavelength characteristic in the hologram optical element is small permits mixture of the colors in the direction that permits enlargement of the optical pupil, thus providing an image with little color unevenness and high image quality to the observer even when a light source having three light emitting parts is used.

In the invention, it is preferable that the light source have an even number of sets of three light emitting parts which emit light respectively corresponding to three primary colors, and that an order in which the light emitting parts are arrayed in the direction vertical to the incidence plane along which the optical axis runs onto the hologram optical element differ between the adjacent sets.

In this case, centers of gravity of light intensities of the respective colors of the light emitted from the respective light emitting parts (sums of light intensities in the respective sets) agree with each other (for example, located on the incidence plane), which permits providing to the observer an image with little color unevenness at or near the center of the optical pupil. This configuration is also applicable to even a case where a hologram optical element having no axis-asymmetric positive optical power is used.

In the invention, it is preferable that the light source have an even number of sets of three light emitting parts which are arranged in plane-symmetric with respect to the incidence plane, and that the light emitting parts located at the same distance from the incidence plane on the both sides in the direction vertical to the incidence plane emit light of a same color. In this case, the centers of gravity of light intensities of the respective colors of light emitted from the respective light emitting parts (sums of light intensities in the respective sets) agree with each other on the incidence plane, which permits providing to the observer an image with little color unevenness at the center of the optical pupil.

In the invention, it is preferable that the light source have two sets of three light emitting parts, and that the light emitting parts in each of the sets are arranged in an order such that the wavelength of the emitted light becomes shorter outwardly in the direction vertical to the incidence plane. In this case, intensity difference depending on the pupil position can be made small for light of a long wavelength, which permits providing to the observer an image with little color unevenness on the entire optical pupil.

In the invention, it is preferable that the hologram optical element described above is a combiner which simultaneously guides image light from the display device and external light to the pupil of the observer. In this case, the observer can simultaneously observe the image provided from the display device and the outside image via the hologram optical element.

In the invention, it is preferable that the half-diffraction-efficiency wavelength width of the hologram optical element be between 5 nm inclusive and 10 nm inclusive. As described above, since the half-diffraction-efficiency wavelength width of the hologram optical element is narrow, the observer can observe a bright image, and since the transmittance of outside light is high, the observer can observe a bright outside image.

In the invention, it is preferable that the observation optical system have a first transparent substrate which totally reflects therein image light from the display device and then guides the image light to the pupil of the observer and, on the other hand, transmits external light and then guides the external light to the pupil of the observer. The use of such a first transparent substrate increases the transmittance of the external light while making it possible to observe the image from the display device, which permits observation of a bright outside image.

In the invention, it is preferable that the observation optical system have a second transparent substrate for canceling diffraction of external light on the first transparent substrate. In this case, occurrence of distortion in an outside image observed by the observer via the observation optical system can be avoided.

From the above description, it is apparent that various modifications can be made to the invention. Thus, it should be understood that the invention is practiced within the appended claims without being caught in the detailed description.

What is claimed is:

1. An image display apparatus comprising:
a pair of right and left light sources,
a pair of right and left display devices which modulate light from the respective light sources to display images,
a pair of right and left observation optical systems which guide light of the images displayed on the respective display devices to a pair of right and left optical pupils, respectively, and
an optical axis adjustment mechanism which, for at least one of right and left, changes relative positional relationship between the image displayed on the display device and the observation optical system in a direction intersecting an optical axis to thereby adjust an angle formed by a pair of right and left optical axes,
wherein, on each of the right and the left, the light source is so arranged as to be substantially conjugate with the optical pupil, and
wherein the optical axis adjustment mechanism changes the positional relationship without changing a position of the optical pupil relative to the observation optical system.

2. The image display apparatus according to claim 1,
wherein the optical axis adjustment mechanism adjusts a position of the display device relative to the observation optical system to thereby change the positional relationship.

3. The image display apparatus according to claim 1, further comprising a pair of right and left illumination optical systems which condense the light from the respective light sources and then guide the light to the respective display devices.

4. The image display apparatus according to claim 1,
wherein the light source is an LED.

5. The image display apparatus according to claim 1,
wherein the light source emits light having a plurality of wavelengths with which light intensity becomes peak.

6. The image display apparatus according to claim 1,
wherein, on each of the right and the left, the observation optical system includes a volume phase type, reflective hologram optical element, the hologram optical element diffracting and reflecting image light from the display device and then guides the image light to the optical pupil.

7. The image display apparatus according to claim 6, further comprising a pair of right and left light source position adjustment mechanisms which adjust positions of the respective light sources to thereby change the positions of the respective optical pupils.

8. The image display apparatus according to claim 6,
wherein the hologram optical element has an axis-asymmetric positive optical power.

9. The image display apparatus according to claim 8,
wherein the optical pupil is larger in a direction vertical to an incidence plane along which the optical axis runs onto the hologram optical element than in a direction parallel to the incidence plane.

10. The image display apparatus according to claim 9,
wherein the light source and the optical pupil are substantially conjugate with each other in the direction parallel to the incidence plane.

11. The image display apparatus according to claim 9,
wherein the light source has three light emitting parts which emit light respectively corresponding to three primary colors, the light emitting parts being arranged alongside the direction vertical to the incidence plane.

12. The image display apparatus according to claim 11,
wherein the light source has an even number of sets of the three light emitting parts, the light emitting parts being so arranged as to be plane-symmetric with respect to the incidence plane and also arranged so that the light emitting parts located at same distance from the incidence plane on both sides in the direction vertical to the incidence plane emit light of the same color.

13. The image display apparatus according to claim 12,
wherein the light source has two sets of the three light emitting parts, the light emitting parts in each of the sets being arranged in an order such that a wavelength of emitted light becomes shorter outwardly in the direction vertical to the incidence plane from an incidence plane side.

14. The image display apparatus according to claim 6,
wherein the light source has an even number of sets of three light emitting parts which emit light respectively corresponding to three primary colors, and
wherein an order in which the light emitting parts are arrayed in the direction vertical to the incidence plane along which the optical axis runs onto the hologram optical element is opposite between the adjacent sets.

15. The image display apparatus according to claim 14,
wherein the light emitting parts are so arranged in plane-symmetric with respect to the incidence plane and also arranged so that the light emitting parts located at same distance from the incidence plane on both sides in the direction vertical to the incidence plane emit light of the same color.

16. The image display apparatus according to claim 15,
wherein the light source has two sets of the three light emitting parts, each set of the light emitting parts being arranged in an order such that a wavelength of emitted light becomes shorter outwardly in the direction vertical to the incidence plane from an incidence plane side.

17. The image display apparatus according to claim 6,
wherein the hologram optical element is a combiner which simultaneously guides the image light from the display device and external light to a pupil of an observer.

18. The image display apparatus according to claim 17,
wherein a half-diffraction-efficiency wavelength width of the hologram optical element is between 5 nm inclusive and 10 nm inclusive.

19. The image display apparatus according to claim 1,
wherein the observation optical system has a first transparent substrate which totally reflects therein image light from the display device and then guides the image light to a pupil of an observer and, on the other hand, transmits external light and then guides the external light to the pupil of the observer.

20. The image display apparatus according to claim 19,
wherein the observation optical system has a second transparent substrate for canceling refraction of the external light on the first transparent substrate.

21. The image display apparatus according to claim 1, further comprising, on each of the right and the left, a case which stores the light source and the display device,
wherein the optical axis adjustment mechanism includes a holding part capable of sliding in the direction intersecting the optical axis while holding the display device, the holding part being fixed to the case after position adjustment of the display device.

22. The image display apparatus according to claim 1, further comprising, on each of the right and the left, a case which stores the light source and the display device,
wherein the optical axis adjustment mechanism includes a holding part which holds the display device in the case, the holding part including: a bias member which, as a support point of the case, biases one end of the display device in the direction intersecting the optical axis; and a position adjustment member which is so provided as to penetrate through the case in the direction and which makes direct contact with another end of the display device in the direction and also moves back and forth in the direction relative to the case to thereby adjust the position of the display device in the direction relative to the case.

23. The image display apparatus according to claim 22,
wherein the position adjustment member is a screw.

24. The image display apparatus according to claim 1, further comprising, on each of the right and the left, a case which stores the light source and the display device,
wherein the case includes: a main body, a lid which is detachable from the main body, and a fixing member which fixes the lid to the main body,
wherein the optical axis adjustment mechanism includes a holding part which holds the display device in the case, the holding part including a bias member which, as a support point of the main body, biases one end of the display device in the direction intersecting the optical axis and an insert member which is inserted between the lid of the case and another end of the display device in the direction, and
wherein, in accordance with width of the insert member in the direction, a position of the display device in the case in the direction is adjusted.

25. The image display apparatus according to claim 24,
wherein the insert member is a spacer having a predetermined width.

26. A head-mounted display comprising:
an image display apparatus, and
support member adapted to support the image display apparatus in front of eyes of an observer, the image display apparatus including: a pair of right and left light sources; a pair of right and left display devices which modulate light from the respective light sources to display images; a pair of right and left observation optical systems which guide light of the images displayed on the respective display devices to a pair of right and left optical pupils, respectively; and an optical axis adjustment mechanism which, for at least one of the right and the left, changes relative positional relationship between the image displayed on the display device and the observation optical system in a direction intersecting an optical axis to thereby adjust an angle formed by a pair of right and left optical axes,
wherein, on each of the right and the left, the light source is so arranged as to be substantially conjugate with the optical pupil, and
wherein the optical axis adjustment mechanism changes the positional relationship without changing a position of the optical pupil relative to the observation optical system.

27. An optical axis adjustment method, comprising the step of adjusting an angle formed by a pair of right and left optical axes in an image display apparatus having light sources, display devices, and observation optical systems all in pairs each on right and left and having, on each of the right and the left, the light source and the optical pupil so arranged as to be substantially conjugate with each other,
wherein, in the step, for at least one of the right and the left, without changing a position of the optical pupil relative to the observation optical system, relative positional relationship between an image displayed on the display device and the observation optical system is changed in a direction intersecting the optical axis to thereby adjust the angle formed by the pair of right and left optical axes.

28. The optical axis adjustment method according to claim 27,
wherein, in the step, a position of the display device relative to the observation optical system is adjusted to thereby change the positional relationship.
